(19) United States
(12) Patent Application Publication
(10) Pub. No.: US 2026/0213064 A1
(43) Pub. Date: Jul. 23, 2026

(54) COIL COMPONENT, METHOD FOR MANUFACTURING COIL COMPONENT, AND ELECTRONIC/ELECTRIC DEVICE

(71) Applicant: DELTA ELECTRONICS (JAPAN), INC., Tokyo (JP)

(72) Inventors: Satoshi MARUYAMA, TOKYO (JP); Takeshi TAKAHASHI, TOKYO (JP); Kosuke CHIMATA, TOKYO (JP); Shuji IGUCHI, TOKYO (JP); Setsuko MARUYAMA, TOKYO (JP)

(73) Assignee: DELTA ELECTRONICS (JAPAN), INC., Tokyo (JP)

(21) Appl. No.: 19/435,493

(22) Filed: Dec. 29, 2025

Related U.S. Application Data
(63) Continuation of application No. PCT/JP2023/024566, filed on Jul. 3, 2023.

(51) Int. Cl. H01F 27/32; H01F 27/255; H01F 41/06

(52) U.S. Cl. CPC H01F 27/324; H01F 27/255; H01F 41/06

(57) ABSTRACT

A coil component includes a coil having an annular conductor having a center axis along a first direction and including two electrical ends; and a main body covering the annular conductor with first and second surfaces aligned in the first direction and containing magnetic powder and binder. Second material constituting a second region including the second surface, and third material constituting a third region including a central region where entire outer edge faces an inner surface of the annular conductor, differ in one or more selected from composition of the magnetic powder, shape distribution regarding shape and content of the magnetic powder, composition and content of the binder, and composition and content of an optional third component other than the magnetic powder and the binder, possibly imparting new function to the main body to make it highly functional. Improvement in various properties of the coil component is realized.

### CROSS REFERENCE TO RELATED APPLICATION

This application is a continuation application of PCT Application No. PCT/JP2023/024566, filed on Jul. 3, 2023. The content of the application is incorporated herein by reference.

### BACKGROUND OF THE INVENTION

### 1. Field of the Invention

The present invention relates to a coil component and a method for manufacturing the same. The present invention also relates to an electronic/electric device, in which the coil component is installed.

### 2. Description of the Related Art

Patent Document 1 discloses a power inductor including a body containing magnetic powder and a polymer, at least one substrate provided inside the body and having at least one coil pattern formed on at least one surface thereof, and an insulating layer formed between the coil pattern and the body, wherein the body includes at least one region in which the particle size distribution of the magnetic powder is different from that of the remaining portion.

### PRIOR ART DOCUMENT

### Patent Document

[Patent Document 1] Japanese National Publication (Tokuhyo) No. 2019-532519

### SUMMARY OF THE INVENTION

### Problems to be Solved by the Invention

In a coil component having a configuration that a coil is embedded in a main body portion, when current flows through the coil, a magnetic circuit formed in the main body portion proceeds in a direction along the central axis of the coil on the inner peripheral side and the outer peripheral side of the coil, and proceeds in a direction crossing the central axis of the coil on two bottom surface sides of the coil. Therefore, it may be preferable that the magnetic characteristics differ between the inner peripheral side and the bottom surface side of the coil within the main body portion. In addition, when the coil component is mounted on a substrate, a portion located on the bottom surface side of the coil in the main body portion becomes a portion facing the substrate or protruding from the substrate. Accordingly, it may be preferable that such portions have electrical characteristics and mechanical characteristics different from those of the portion located on the inner peripheral side of the coil within the main body portion.

An object of the present invention is to provide a coil component in which the function of the main body portion is enhanced. Another object of the present invention is to provide a manufacturing method of the coil component and an electronic/electric device in which the coil component is mounted.

### Means to Solve the Problems

According to one aspect of the present invention provided to solve the above problems, there is provided a coil component including: a coil member having an annular conductor portion with a central axis along a first direction and having two electrical ends; and a main body portion covering the annular conductor portion with a first surface and a second surface aligned in the first direction, and containing magnetic powder and a binder. The coil member is exposed from the surface of the main body portion at a first end surface connected to one of the two electrical ends of the annular conductor portion and at a second end surface connected to the other of the two electrical ends of the annular conductor portion. The main body portion includes a first region formed of a first material and including the first surface, a second region formed of a second material and including the second surface, and a third region formed of a third material and located between the first surface and the second surface in the first direction. The third region includes a central region in which the entire outer peripheral edge faces the inner peripheral surface of the annular conductor portion. The second material and the third material differ in one or more selected from the group consisting of: composition of the magnetic powder, shape distribution which is a distribution regarding shapes of the magnetic powder, content of the magnetic powder, composition of the binder, content of the binder, and, when a third component other than the magnetic powder and the binder is contained, composition and content thereof.

In the above coil component, the material of the third region including the central region can be made different from the material located near the intersecting surface. By doing so, new function can be imparted to the main body portion, and the main body portion can be made highly functional.

In the above coil component, the first material and the second material may be identical. In this case, the region including the central region can have properties different from other regions.

In the above coil component, the first material and the second material may differ in one or more selected from the group consisting of: the composition of the magnetic powder, the shape distribution of the magnetic powder, the content of the magnetic powder, the composition of the binder, the content of the binder, and, when the third component other than the magnetic powder and the binder is contained, the composition and content thereof. When the first region and the second region have different properties, additional function can be imparted to the main body portion, and the main body portion may be made highly functional.

In the above coil component, the first material and the third material may be identical. By making only the material located near the second surface different, the second region may have unique characteristics different from other regions.

In the above coil component, the annular conductor portion may contact at least one of the first region and the second region at the end portion in the first direction. Because the third material does not exist between the annular conductor portion and the first region or the second region, the advantages of providing the first region and the second region (e.g., positional stability of the coil member within the main body portion, suppression of insulation breakdown, etc.) may be more stably acquired.

In the above coil component, the third region may extend in the first direction so as to contact at least one of the two end portions in the first direction of the annular conductor portion. Since the third material extends at least between the annular conductor portion and the first region or between the annular conductor portion and the second region, the advantages of forming the third region from the third material (e.g., suppression of short-circuiting in the annular conductor portion due to local breakage of the insulation portion) may be more stably obtained.

In the above coil component, the second material may be harder than the third material. Since the second region is mostly a region where the coil member is not present, making this region harder makes defects or deformation of the main body portion less likely to occur. In addition, when the main body portion is formed by pressurizing a material containing magnetic powder and a curable material in the first direction, positional control of the coil member within the main body portion becomes easier.

In the above coil component, a second area ratio, which is an area ratio of the magnetic powder on a second cut surface obtained by cutting the second region on a plane perpendicular to the first direction, may be higher than a third area ratio, which is an area ratio of the magnetic powder on a third cut surface obtained by cutting the third region on a plane perpendicular to the first direction. In this case, the second region tends to be harder.

In the above coil component, the second material may have higher insulation property than the third material. When the second surface is a mounting surface, short-circuiting on the mounting surface side is less likely to occur. In particular, when lower surface electrodes are provided, short-circuiting between the lower surface electrodes is less likely to occur. When the second surface is on the side opposite the mounting surface, the second region is relatively susceptible to impact such as collisions; however, even if peeling occurs in the outer cover due to an impact, insulation breakdown is less likely to occur.

In the above coil component, the resistivity of the second region may be greater than the resistivity of the third region. In this case, it is easier to realize that the second material has higher insulation property than the third material.

In the above coil component, the magnetic powder contained in the second material may include a metallic magnetic powder, and the relative permeability μ2 of the second region may be smaller than the relative permeability μ1 of the first region. As one means for relatively increasing the insulation property of the second region, the content of the insulating material in the second material can be increased. In this case, since the content of the metallic magnetic powder is relatively reduced, the relative permeability μ2 of the second region tends to be smaller than the relative permeability μ1 of the first region.

In the above coil component, the length h2 of the second region in the first direction may be larger than the length h1 of the first region in the first direction. Even when the relative permeability μ2 of the second region is smaller than the relative permeability μ1 of the first region, if h2>h1, an excessive increase in the magnetic reluctance of the second region can be avoided.

In the above coil component, when the second region is cut on a plane perpendicular to the first direction to obtain a second cut surface, and the third region is cut on a plane perpendicular to the first direction to obtain a third cut surface, at least one of the following (A) or (B) may be satisfied: (A) The second area ratio, which is the area ratio of the magnetic powder on the second cut surface, is lower than the third area ratio, which is the area ratio of the magnetic powder on the third cut surface; and (B) The second average circle equivalent diameter, which is the average circle equivalent diameter of the magnetic powder on the second cut surface, is larger than the third average circle equivalent diameter, which is the average circle equivalent diameter of the magnetic powder on the third cut surface.

Regarding (A), by setting the second area ratio<the third area ratio, μ2<μ3 tends to be realized. In this case, since the area ratio of the binder becomes higher in the second region, the insulation property of the second region tends to increase.

Regarding (B), when the average circle equivalent diameter of the magnetic powder is relatively large, the packing density tends to decrease. Therefore, by setting the second average circle equivalent diameter>the third average circle equivalent diameter, μ2<μ3 tends to be realized. In this case, since the area ratio of the binder tends to increase in the second region, the resistivity of the second region tends to increase.

In the above coil component, the second material may contain insulating inorganic particles as the third component. Many insulating inorganic particles have a higher breakdown voltage than the binder, and this tendency is remarkable when the binder is a polymer. By containing inorganic particles as the third component in the second material, the possibility of insulation breakdown occurring in the second region can be reduced.

In the above coil component, the magnetic powder contained in the second material may include a metallic magnetic powder provided with an insulating coating on its surface. When the magnetic powder is a metallic magnetic powder, the magnetic powder forms a conductive path upon insulation breakdown. Therefore, when the metallic magnetic powder has an insulating coating on its surface, the possibility of insulation breakdown occurring in the second region may be reduced.

In the above coil component, the annular conductor portion may have an insulation portion on its surface, and the magnetic powder contained in the third material may include a metallic magnetic powder. When the second region is cut on a plane perpendicular to the first direction to obtain a second cut surface and the third region is cut on a plane perpendicular to the first direction to obtain a third cut surface, at least one of the following (a) to (d) may be satisfied: (a) The third average circle equivalent diameter, which is the average circle equivalent diameter of the magnetic powder on the third cut surface, is smaller than the second average circle equivalent diameter, which is the average circle equivalent diameter of the magnetic powder on the second cut surface; (b) The third median diameter, which is the median diameter of the magnetic powder on the third cut surface, is smaller than the second median diameter, which is the median diameter of the magnetic powder on the second cut surface; (c) The third maximum circle equivalent diameter, which is the maximum circle equivalent diameter of the magnetic powder on the third cut surface, is smaller than the second maximum circle equivalent diameter, which is the maximum circle equivalent diameter of the magnetic powder on the second cut surface; and (d) At least one of the second diameter distribution, which is the distribution of circle equivalent diameters of the magnetic powder on the second cut surface, and the third diameter distribution, which is the distribution of circle equivalent diameters of the magnetic powder on the third cut surface, has two or more peaks, and a third peak diameter, which is a circle equivalent diameter at the maximum frequency of the largest-diameter-side peak in the third diameter distribution, is smaller than a second peak diameter, which is a circle equivalent diameter at the maximum frequency of the largest-diameter-side peak in the second diameter distribution.

Regarding (a), since smaller-particle-size magnetic powder is relatively more likely to exist in the third region, when the main body portion is formed by including pressurizing a material containing the magnetic powder in the first direction, short-circuiting inside the annular conductor portion is less likely to occur even if the insulation portion provided on the surface of the annular conductor portion is locally broken by the magnetic powder due to the pressurization.

Regarding (b), since smaller-particle-size magnetic powder is relatively more likely to exist in the third region, when the main body portion is formed by including pressurizing a material containing the magnetic powder in the first direction, short-circuiting inside the annular conductor portion is less likely to occur even if the insulation portion provided on the surface of the annular conductor portion is locally broken by the magnetic powder due to the pressurization.

Regarding (c), since smaller-particle-size magnetic powder is relatively more likely to exist in the third region, when the main body portion is formed by including pressurizing a material containing the magnetic powder in the first direction, short-circuiting inside the annular conductor portion is less likely to occur even if the insulation portion provided on the surface of the annular conductor portion is locally broken by the magnetic powder due to the pressurization.

Regarding (d), since smaller-particle-size magnetic powder is relatively more likely to exist in the third region, when the main body portion is formed by including pressurizing a material containing the magnetic powder in the first direction, short-circuiting inside the annular conductor portion is less likely to occur even if the insulation portion provided on the surface of the annular conductor portion is locally broken by the magnetic powder due to the pressurization.

In the above coil component, the annular conductor portion may have an insulation portion on its surface, the magnetic powder contained in the third material may include a metallic magnetic powder, and at least one of a second particle size distribution, which is a volume-based particle size distribution of the magnetic powder contained in the second region, and a third particle size distribution, which is a volume-based particle size distribution of the magnetic powder contained in the third region, may have two or more peaks. In this case, a third particle size, which is a particle size at the maximum frequency of the largest-diameter-side peak among the peaks in the third particle size distribution, may be smaller than a second particle size, which is a particle size at the maximum frequency of the largest-diameter-side peak among the peaks in the second particle size distribution.

Since smaller-particle-size magnetic powder is relatively more likely to exist in the third region, when the main body portion is formed by including pressurizing a material containing the magnetic powder in the first direction, short-circuiting inside the annular conductor portion is less likely to occur even if the insulation portion provided on the surface of the annular conductor portion is locally broken by the magnetic powder due to the pressurization.

In the above coil component, the binder contained in the second region may contain a second polymer, and the binder contained in the third region may contain a third polymer. The physical properties of polymers can be easily adjusted by adjusting the monomer composition and polymerization. Therefore, by containing polymers in the binder, the properties of the binder can be easily adjusted.

In the above coil component, the weight average molecular weight of the second polymer may be larger than the weight average molecular weight of the third polymer. Since the second region containing a polymer with a relatively large molecular weight tends to have high strength and high viscosity as a whole, it can be excellent in impact resistance.

The density of unreacted groups in the second polymer may be lower than the density of unreacted groups in the third polymer. Since the second region containing a polymer with a relatively low density of unreacted groups tends to have high strength and high viscosity as a whole, it can be excellent in impact resistance.

In the above coil component, when the second material contains a polymerization catalyst for forming the binder and the third material contains a polymerization catalyst for forming the binder, the content of the polymerization catalyst in the second material may be higher than the content of the polymerization catalyst in the third material. Since the second region containing a polymer with a relatively high polymerization catalyst content tends to have high strength and high viscosity as a whole, it can be excellent in impact resistance.

In the above coil component, the hardness of the binder contained in the second region measured by a nanoindenter may be smaller than the hardness of the binder contained in the third region measured by a nanoindenter. Since the second region containing a relatively hard binder tends to have high strength and high viscosity as a whole, it can be excellent in impact resistance.

As another aspect, the present invention provides a manufacturing method of a coil component including: a coil member having an annular conductor portion with a central axis in a first direction and having two electrical ends; and a main body portion covering the annular conductor portion with a pair of intersecting surfaces aligned in the first direction and containing magnetic powder. In this manufacturing method, a laminated structure is placed inside a cavity of a mold, wherein the laminated structure includes: the coil member; a first member positioned on one side of the coil member in the first direction and containing a first magnetic powder and a first curable material; a second member positioned on the other side of the coil member in the first direction and containing a second magnetic powder and a second curable material; and a third member positioned between the first member and the second member and containing a third magnetic powder and a third curable material. Then, the manufacturing method includes obtaining a formed body having the coil member and the main body portion from the laminated structure, including increasing the pressure in the cavity. In the formed body, a central region in which the entire outer peripheral edge faces the inner peripheral surface of the annular conductor portion is formed of a material based on the third member.

In this way, by dividing the material constituting the main body portion into a plurality of pieces and integrating them through shape-forming, it becomes easy for the central region of the main body portion to have properties different from other regions.

In the above manufacturing method of a coil component, the second member and the third member may differ in one or more selected from the group consisting of: the composition of the second magnetic powder and the composition of the third magnetic powder; the particle size distribution of the second magnetic powder and the particle size distribution of the third magnetic powder; the content of the second magnetic powder in the second member and the content of the third magnetic powder in the third member; the composition of the second curable material and the composition of the third curable material; the content of the second curable material in the second member and the content of the third curable material in the third member; and, when the second member contains a second additive component other than the second curable material and the second magnetic powder, and the third member contains a third additive component other than the third curable material and the third magnetic powder, the composition of the second additive component and the composition of the third additive component.

In this specification, “curable material” includes materials that cure and materials that cause curing (such as polymerization initiators). In addition, “additive component” is a material that is not a ferromagnetic body and does not react with the curable material, and specific examples thereof include non-polymerizable materials for softening members and inorganic particles for improving insulation.

In the above manufacturing method of a coil component, the first member and the third member may have an identical composition. In this case, the first member and the third member may be an integrated unit. Thereby, productivity may be improved.

In the above manufacturing method of a coil component, the manufacturing method may include curing the first curable material through the third curable material. In this case, the first direction is along the vertical direction, the second member is positioned below the coil member, and the second member may be harder than the third member.

When the second member is harder than the third member, at least one of the following (I) to (VI) may be satisfied: (I) For the laminated structure placed inside the cavity, the viscosity of the second curable material is higher than the viscosity of the third curable material; (II) For the laminated structure placed inside the cavity, the degree of polymerization of the second curable material is higher than the degree of polymerization of the third curable material; (III) For the laminated structure placed inside the cavity, the content of uncured material contained in the second curable material is smaller than the content of uncured material contained in the third curable material; (IV) The second curable material and the third curable material contain a polymerization catalyst, and for the laminated structure placed inside the cavity, the content of the polymerization catalyst in the second curable material is higher than the content of the polymerization catalyst in the third curable material; (V) For the laminated structure placed inside the cavity, the volume fraction of the second magnetic powder contained in the second member is higher than the volume fraction of the third magnetic powder contained in the third member; and (VI) When the gel time, as defined in JIS K5600-9-1:2006, is measured for the second curable material and the third curable material of the laminated structure placed inside the cavity, the gel time of the second curable material is shorter than the gel time of the third curable material.

In the above manufacturing method of a coil component, the second member may have higher insulation property than the third member.

In the above manufacturing method of a coil component, the coil member may have an insulation portion covering the surface of the annular conductor portion, the third magnetic powder may include a metallic magnetic powder, and when the second member is cut on a plane perpendicular to the first direction to obtain a second member cut surface and the third member is cut to obtain a third member cut surface, at least one of the following (i) to (iv) may be satisfied: (i) The third member average circle equivalent diameter, which is the average circle equivalent diameter of the third magnetic powder on the third member cut surface, is smaller than the second member average circle equivalent diameter, which is the average circle equivalent diameter of the second magnetic powder on the second member cut surface; (ii) The third member median diameter, which is the median diameter of the third magnetic powder on the third member cut surface, is smaller than the second member median diameter, which is the median diameter of the second magnetic powder on the second member cut surface; (iii) The third member maximum circle equivalent diameter, which is the maximum circle equivalent diameter of the third magnetic powder on the third member cut surface, is smaller than the second member maximum circle equivalent diameter, which is the maximum circle equivalent diameter of the second magnetic powder on the second member cut surface; and (iv) At least one of the second member diameter distribution, which is the distribution of circle equivalent diameters of the second magnetic powder on the second member cut surface, and the third member diameter distribution, which is the distribution of circle equivalent diameters of the third magnetic powder on the third member cut surface, has two or more peaks, and the third member peak diameter, which is the circle equivalent diameter at the maximum frequency of the largest-diameter-side peak among the peaks in the third member diameter distribution, is smaller than the second member peak diameter, which is the circle equivalent diameter at the maximum frequency of the largest-diameter-side peak among the peaks in the second member diameter distribution.

As another aspect, the present invention provides an electronic/electric device in which the above coil component is mounted, wherein the coil component is connected to a substrate via terminal members provided on exposed conductor portions located at each of two ends of the coil member and exposed to the outside. Examples of such an electronic/electric device include a power supply device equipped with a power supply switching circuit, a voltage step-up/step-down circuit, a smoothing circuit, etc., and a small portable communication device. Since the electronic/electric device according to the present invention includes the above coil component, the overall properties as an inductance element are excellent.

### Effects of the Invention

According to the present invention, new functions can be imparted to the main body portion of the coil component, such as a function of suppressing chipping upon impact, a function of ensuring insulation with respect to external electrodes, a function of suppressing short-circuiting inside the coil member, and a function of positioning the coil member within the main body portion. By imparting such functions, the main body portion becomes highly functional, and a coil component having excellent electrical properties and other various properties is provided. When this coil component is mounted in an electronic/electric device, the performance of the electronic/electric device can be improved, and the dimensions of the electronic/electric device can be reduced. Furthermore, according to the present invention, an electronic/electric device in which the coil component is mounted is provided. In addition, a manufacturing method of the above coil component is also provided.

### BRIEF DESCRIPTION OF THE DRAWINGS

FIG. 1 is a perspective view conceptually illustrating the shape of a coil component according to an embodiment of the present invention.

FIG. 2 is an XZ sectional view taken along line A-A′ in FIG. 1.

FIG. 3 is an XZ sectional view illustrating a state in which a coil component is mounted on a substrate.

FIG. 4 is an XY sectional view taken along line B-B′ in FIG. 2.

FIG. 5 is an XZ sectional view illustrating a modified example of a coil component (Part 1) according to an embodiment of the present invention.

FIG. 6 is an XZ sectional view illustrating a modified example of a coil component (Part 2) according to an embodiment of the present invention.

FIG. 7 is a diagram illustrating the distinction in shape distribution of magnetic powder.

FIG. 8A is a diagram illustrating an example of the function of a main body portion of a coil component (comparative example) according to an embodiment of the present invention.

FIG. 8B is a diagram illustrating an example of the function of a main body portion of a coil component (example of the present invention) according to an embodiment of the present invention.

FIG. 8C is a diagram illustrating the distinction in shape distribution of magnetic powder.

FIG. 9 is an XZ sectional view illustrating a modified example of a coil component (Part 3) according to an embodiment of the present invention.

FIG. 10 is an XZ sectional view illustrating a modified example of a coil component (Part 4) according to an embodiment of the present invention.

FIG. 11A is an XY plan view illustrating an example of a manufacturing method of a coil component according to an embodiment of the present invention (Part 1), showing a coil array sheet.

FIG. 11B is an XZ sectional view taken along line C-C′ in FIG. 11A.

FIG. 12 is an XZ sectional view illustrating an example of a manufacturing method of a coil component according to an embodiment of the present invention (Part 2), showing a state of a coil array sheet, etc., inside a mold cavity.

FIG. 13 is an XZ sectional view illustrating an example of a manufacturing method of a coil component according to an embodiment of the present invention (Part 3), showing a state of a formed body, which is formed with a mold.

FIG. 14 is an XZ sectional view illustrating an example of a manufacturing method of a coil component according to an embodiment of the present invention (Part 4), showing a state before the formed body is cut.

FIG. 15 is an XZ sectional view illustrating an example of a manufacturing method of a coil component according to an embodiment of the present invention (Part 5), showing a state of a coil chip obtained by cutting the formed body.

FIG. 16A is a diagram illustrating a modified example of a manufacturing method of a coil component according to an embodiment of the present invention (Part 1).

FIG. 16B is an XZ sectional view taken along line C-C′ in FIG. 16A.

FIG. 17 is a diagram illustrating a modified example of a manufacturing method of a coil component according to an embodiment of the present invention (Part 2).

FIG. 18 is a diagram illustrating a modified example of a manufacturing method of a coil component according to an embodiment of the present invention (Part 3).

### DETAILED DESCRIPTION

Hereinafter, embodiments of the present invention will be described in detail with reference to the drawings.

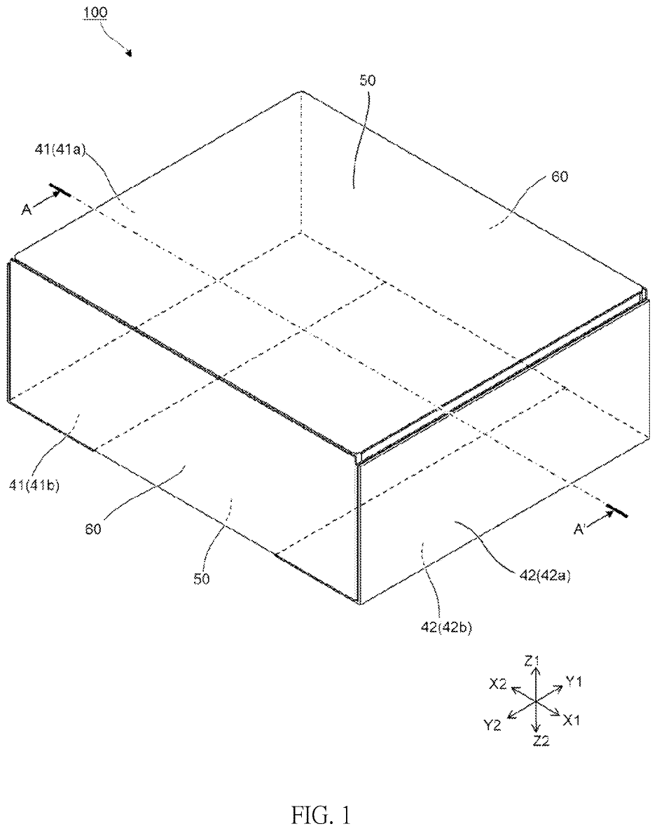

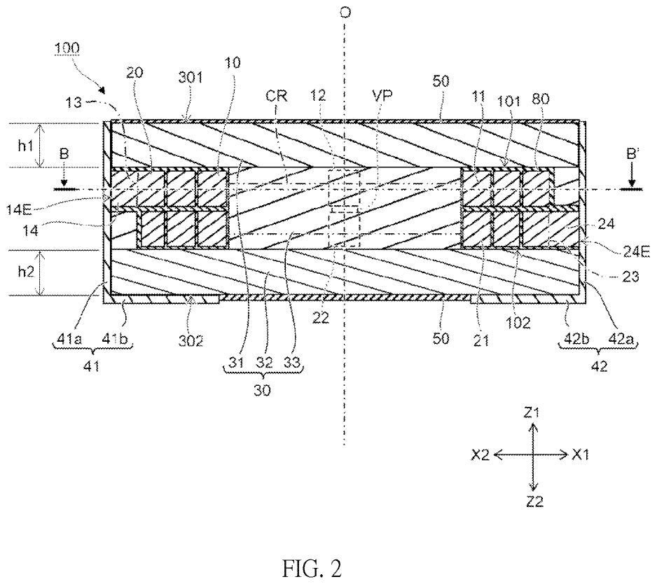

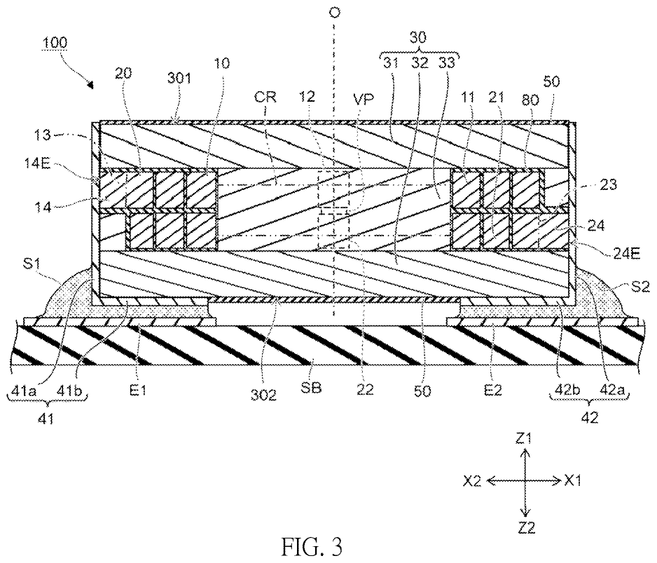

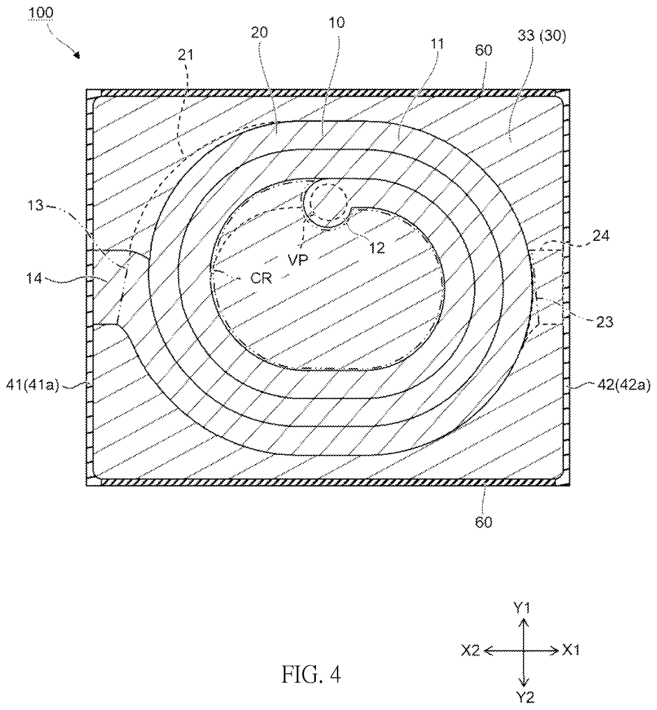

FIG. 1 is a perspective view conceptually illustrating the shape of a coil component regarding one embodiment of the present invention. FIG. 2 is an XZ sectional view taken along line A-A′ in FIG. 1. FIG. 3 is an XZ sectional view illustrating a state in which the coil component is mounted on a substrate. FIG. 4 is an XY sectional view taken along line B-B′ in FIG. 2.

### (Overall Configuration)

A coil component 100 according to an embodiment of the present invention includes a coil member 10 having a coil conductor portion 20, a main body portion 30, a first external electrode 41, a second external electrode 42, and outer covers 50 and 60.

### (Coil)

As shown in FIG. 2 to FIG. 4, the coil member 10 includes a coil conductor portion 20 having a first spiral conductor portion 11 that is spirally formed around a central axis O extending in a first direction (Z1-Z2 direction). The first spiral conductor portion 11 is an example of a part of an annular conductor portion. As for the spiral shape of the first spiral conductor portion 11, it extends outward from an inner-side end part 12, which is the inner-side end part of one pair of ends of the first spiral conductor portion 11, toward an outer-side end part 13, which is the outer-side end part of the pair of ends, such that it moves away from the central axis O. In FIG. 4, as viewed from the Z1 side in the Z1-Z2 direction, the conductor is arranged such that it spirals outward from the inner-side end part 12 toward the outer-side end part 13 in a clockwise direction. In this specification, the term “spiral direction” in the spiral portion refers to the direction from the inner-side end part toward the outer-side end part.

The conductor (electrically conductive material) constituting the coil conductor portion 20 is not particularly limited as long as it has appropriate electrical conductivity. Examples include metals such as copper, copper alloys, aluminum, and aluminum alloys, and the coil conductor portion 20 may be manufactured using a film-forming technique such as plating. The coil member 10 includes a coil insulator portion 80 on the surface of the coil conductor portion 20. The coil insulator portion 80 ensures insulation between adjacent conductors (between opposing conductor surfaces). Examples of materials for the coil insulator portion 80 include resin materials, but the material is not limited to specific ones and may be inorganic materials or hybrids of organic and inorganic materials. The coil insulator portion 80 is not provided at the distal ends of the two terminals (first lead-out end part 14E and second lead-out end part 24E) of the coil conductor portion 20 so that the coil member 10 can be electrically connected to other members at these ends.

The coil insulator portion 80 may be thermoplastic, and thermoplastic resins including parylene-based polymers are examples. Other examples of thermoplastic resins include polyethylene, polypropylene, polyamide, polyester, polyamide-imide, polyimide, polysulfone, polycarbonate, liquid crystal polymer, polyvinylidene fluoride, polytetrafluoroethylene, and the like. The coil insulator portion 80 only needs to be thermoplastic as a whole and may further contain inorganic insulating particles. As materials other than thermoplastic resins, organic materials such as thermosetting resins or inorganic materials such as oxides may be used.

It is preferable that the coil insulator portion 80 exhibit excellent insulation properties. Specifically, its volume resistivity obtained in accordance with ASTM D257 is preferably 1.0×10¹^{⁴} Ω·cm or more. More preferably, it is 1.0×10¹^{⁵} Ω·cm or more, and even more preferably 1.0×10¹^{⁶} Ω·cm or more. The upper limit of the volume resistivity is not particularly restricted and may be 1.0×10²^{⁰} Ω·cm or less. It is also preferable that the coil insulator portion 80 exhibit excellent dielectric properties. Specifically, its relative permittivity at 60 Hz obtained in accordance with ASTM D150 is preferably 4.0 or less, more preferably 3.5 or less, and even more preferably 3.0 or less. The lower limit of relative permittivity is not particularly restricted and may be 1.0 or more. The methods for measuring the volume resistivity and relative permittivity of the coil insulator portion 80 are not limited as long as the results are equivalent to those obtained by ASTM D257 and ASTM D150. For example, a measurement sample prepared to the required dimensions using a material corresponding to the coil insulator portion 80 may be separately prepared, and the properties such as volume resistivity may be evaluated through component analysis or FT-IR analysis for material identification.

As shown in FIGS. 2 to 4, the coil conductor portion 20 includes a second spiral conductor portion 21 disposed alongside the first spiral conductor portion 11 in the first direction. The second spiral conductor portion 21 is another example of a part of an annular conductor portion. Around the central axis O extending in the first direction (Z1-Z2 direction), the second spiral conductor portion 21 spirals away from the central axis O from one end of the second spiral conductor portion 21, which is the inner-side end (inner-side end part 22), to the other end of the second spiral conductor portion 21, which is the outer-side end (outer-side end part 23). As viewed from the Z1 side in the Z1-Z2 direction, the conductor is spirally configured so that the second spiral conductor portion 21 spirals away from the central axis O in the direction opposite to that of the first spiral conductor portion 11 (counterclockwise in FIG. 2).

The average clearance in the first direction (Z1-Z2 direction) between the first spiral conductor portion 11 and the second spiral conductor portion 21 is not particularly limited. A smaller clearance makes it easier to reduce the height (dimension in the Z1-Z2 direction) of the coil component 100, but an excessively small clearance may reduce the insulation between the two spiral conductor portions. From the viewpoint of achieving both a low profile of the coil component 100 and high insulation between the two spiral conductor portions, the clearance is preferably 0.4 μm or more and 20 μm or less. From the manufacturing viewpoint, to reduce variations in the clearance and to ensure more reliable support on the same plane of the coil, the clearance is more preferably 1.0 μm or more, and even more preferably 5.0 μm or more.

The inner-side end part 12 of the first spiral conductor portion 11 and the inner-side end part 22 of the second spiral conductor portion 21 are electrically connected by a via part VP. Starting from the connection portion to the via part VP, the first spiral conductor portion and the second spiral conductor portion spiral in opposite directions. The via part VP may be formed of the same conductor material as the coil conductor portion 20. In a specific example, the via part VP is simultaneously manufactured in the process of manufacturing the first spiral conductor portion and the second spiral conductor portion. In this embodiment, the via part VP is integrated with the inner-side end part 12 of the first spiral conductor portion 11 and the inner-side end part 22 of the second spiral conductor portion 21. Thus, in this embodiment, the annular conductor portion includes the first spiral conductor portion 11, the second spiral conductor portion 21, and the via part VP, and the outer-side end parts 13 and 23 are the two electrical ends of the annular conductor portion.

A first lead-out portion 14 is continuously disposed at the outer-side end part 13 of the first spiral conductor portion 11, and a second lead-out portion 24 is continuously disposed at the outer-side end part 23 of the second spiral conductor portion 21. Accordingly, the outer-side end part 13 of the first spiral conductor portion 11 substantially serves as an interface with the first lead-out portion 14, and the outer-side end part 23 of the second spiral conductor portion 21 substantially serves as an interface with the second lead-out portion 24. In a specific example, the first lead-out portion 14 and second lead-out portion 24 are manufactured in the same manufacturing process as the first spiral conductor portion 11 and the second spiral conductor portion 21. In this embodiment, the first lead-out portion 14 is integrated seamlessly with the outer-side end part 13 of the first spiral conductor portion 11, and the second lead-out portion 24 is integrated seamlessly with the outer-side end part 23 of the second spiral conductor portion 21.

In other words, in this embodiment, the coil conductor portion 20 includes the first spiral conductor portion 11, the first lead-out portion 14, the second spiral conductor portion 21, the second lead-out portion 24, and the via part VP, all of which are manufactured to have integrated portions in a common manufacturing process.

### (External Electrodes)

As shown in FIG. 1, the coil component 100 according to this embodiment includes external electrodes provided outside the main body portion 30 as terminal members of the coil component 100. In other words, the external electrodes are provided on exposed conductor portions where the coil member 10 is exposed to the outside. Specifically, the coil component 100 includes a first external electrode 41 that contacts the first lead-out end part 14E, and a second external electrode 42 that contacts the second lead-out end part 24E. The first external electrode 41 includes a first lateral external electrode 41a located on an outer side surface of the main body portion 30, and a first intersecting-surface external electrode 41b located on the second surface 302 of the main body portion 30, and these are continuous with each other. The second external electrode 42 includes a second lateral external electrode 42a located on an outer side surface of the main body portion 30, and a second intersecting-surface external electrode 42b located on the second surface 302 of the main body portion 30, and these are continuous with each other. When a first lateral external electrode 41a and a second lateral external electrode 42a are provided, solder S1 is located between a first substrate electrode E1, which extends on the substrate SB in the X1-X2 direction from a position sufficiently distal from the first lateral external electrode 41a (on X2 side in X1-X2 direction) to a position facing the second surface 302, and the first lateral external electrode 41a, and also between the first substrate electrode E1 and the first intersecting-surface external electrode 41b. Similarly, solder S2 is located between the second substrate electrode E2, which extends on the substrate SB in the X1-X2 direction from a position sufficiently distal from the second lateral external electrode 42a (X1 side in X1-X2 direction) to a position facing the second surface 302, and the second lateral external electrode 42a, and also between the second substrate electrode E2 and the second intersecting-surface external electrode 42b.

The materials and structures of the first external electrode 41 and the second external electrode 42 are not limited as long as they have appropriate electrical conductivity. As an unrestricted example, a multilayer structure of Cu plating/Ni plating/Sn plating provided on the surface of the main body portion 30 may be used. The first external electrode 41 and the second external electrode 42 may also be formed of a coating-type electrode in which conductive materials such as silver are dispersed in a resin. A combination of plating and coating-type electrodes may also be employed.

### (Main Body Portion)

The main body portion 30 covers the first spiral conductor portion 11 and the second spiral conductor portion 21 with at least a pair of intersecting surfaces (first surface 301 and second surface 302) arranged in the first direction (Z1-Z2 direction), and contains magnetic powder and a binder. In this embodiment, the main body portion 30 has four outer side surfaces extending in the first direction (Z1-Z2 direction) between the pair of intersecting surfaces, and has a substantially rectangular parallelepiped shape. The main body portion 30 encloses portions of the coil member 10 except for the end surfaces at the most outer positions (X2 side in X1-X2 direction and both sides in Z1-Z2 direction) of the first lead-out portion 14, and the most outer positions (X1 side in X1-X2 direction and both sides in Z1-Z2 direction) of the second lead-out portion 24.

The coil member 10 is exposed from the surface of the main body portion 30 at a first end surface (first lead-out end part 14E) connected to one of the two electrical ends (outer-side end part 13) of the annular conductor portion, and at a second end surface (second lead-out end part 24E) connected to the other electrical end (outer-side end part 23) of the annular conductor portion.

The main body portion 30 is composed of a first region 31 formed of a first material and including the first surface 301, a second region 32 formed of a second material and including the second surface 302, and a third region 33 formed of a third material and located between the first surface 301 and the second surface 302 in the first direction. The third region 33 includes a central region CR in which the entire outer peripheral edge faces the inner peripheral surface of the annular conductor portion (the first spiral conductor portion 11, the second spiral conductor portion 21, and the via part VP). The length (thickness) of the central region CR in the first direction is appropriately set according to required characteristics of the central region CR and the shape of the inner peripheral side of the annular conductor portion. The thickness of the central region CR may be equal to the length of the annular conductor portion in the first direction (thickness of annular conductor portion), and may also be one-half of the thickness of the annular conductor portion, or, for example, one-fourth thereof. When the thickness of the central region CR is smaller than that of the annular conductor portion, the central region CR may be located closer to the first region 31, or may be located closer to the second region 32, or may be positioned substantially equidistant from the first region 31 and the second region 32.

In this embodiment, the second material and the third material differ in at least one of the following items [1] to [6]:
[1] composition of the magnetic powder,
[2] shape distribution relating to shapes of the magnetic powder,
[3] content of the magnetic powder,
[4] composition of the binder
[5] content of the binder, and
[6] composition and content of a third component contained other than the magnetic powder and the binder.

By making the second material and the third material differ in at least one of the above items, a main body portion 30 in which the characteristics of the second region 32 and the third region 33 differ from each other can be obtained.

In the main body portion 30, the first material and the second material may be identical. In this case, the third region 33 including the central region CR can have characteristics different from other regions. For example, in the first region 31 and the second region 32, when the coil component 100 is energized, a magnetic circuit is formed in a direction intersecting the first direction. Therefore, by forming these regions from the same material, a local increase in magnetic reluctance can be suppressed. In addition, since the first region 31 includes the first surface 301, and the second region 32 includes the second surface 302, the first region 31 and the second region 32 being hard may improve the resistance to external impact.

In the main body portion 30, the first material and the second material may also differ in one or more items selected from the above items [1] to [6]. When the first region 31 and the second region 32 have different characteristics, additional functions can be imparted to the main body portion 30. For example, as shown in FIG. 3, when the coil component 100 is mounted on the substrate SB, since the first region 31 does not face the substrate SB, the first material may be made relatively harder to improve resistance to external impact, and the second region 32, which faces the mounting surface, may be formed such that the insulating property of the second material is relatively higher.

In the main body portion 30, the first material and the third material may be identical. By making only the second material located near the second surface 302 different from the other materials, the second region 32 can have characteristics different from other regions, thereby imparting a new function to the main body portion 30 and improving the performance of the main body portion 30.

The positional relationship between the boundaries of the first region 31, the third region 33, and the second region 32 aligned in the first direction, and the end portion in the first direction, where the annular conductor portion of the coil member 10 is located, is not particularly limited. For example, the part where the annular conductor portion of the coil member 10 is located may contact at least one of the first region 31 and the second region 32 at the end portion in the first direction. In FIG. 2, the end portion (first end portion 101) on the Z1 side of the part where the first spiral conductor portion 11 is located contacts the first region 31, and the end portion (second end portion 102) on the Z2 side of the part where the second spiral conductor portion 21 is located contacts the second region 32. In this way, by having no third material between the part where the annular conductor portion is located and the first region 31, and/or between the part where the annular conductor portion is located and the second region 32, the advantages provided by the first region 31 and the second region 32 (e.g., improved positional stability of the coil member 10 in the main body portion 30, improved insulation, etc.) can be more stably acquired.

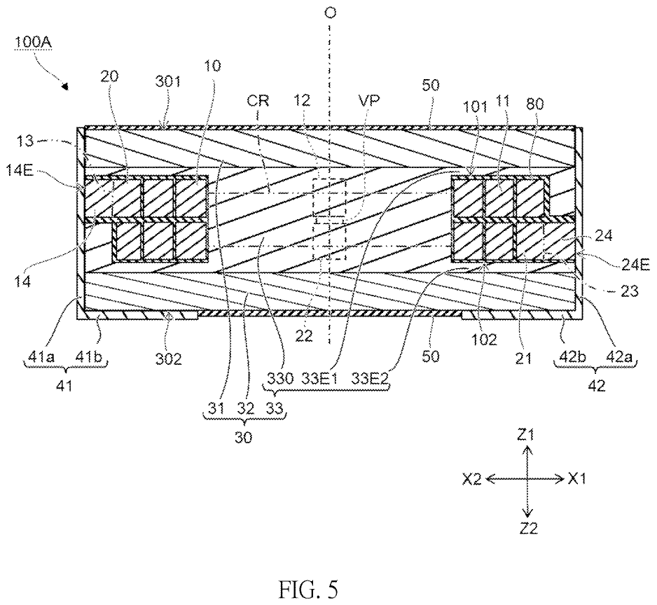

FIG. 5 is an XZ sectional view illustrating a modified example of the coil component (Part 1) according to an embodiment of the present invention. As shown in the coil component 100A in FIG. 5, the third region 33 may extend in the first direction to contact at least one of the two end portions (the first end portion 101 and the second end portion 102) in the first direction of the part where the annular conductor portion of the coil member 10 is located. In FIG. 5, the third region 33 extends to both sides in the first direction (Z1 side and Z2 side), and includes a first extension portion 33E1 contacting the first end portion 101 of the coil member 10 and a second extension portion 33E2 contacting the second end portion 102 of the coil member 10. Thus, by allowing the third material to extend at least between the part where the annular conductor portion is located and the first region 31, or at least between the part where the annular conductor portion is located and the second region 32, the advantages of forming the third region 33 with the third material (e.g., suppression of short-circuiting in the coil member 10 due to local breakage of the insulator) can be more stably obtained.

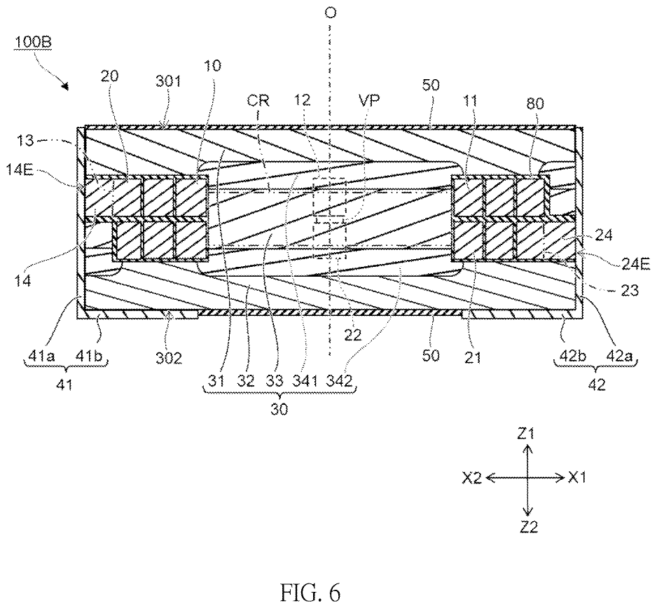

FIG. 6 is an XZ sectional view illustrating a modified example of the coil component (Part 2) according to an embodiment of the present invention. As shown in the coil component 100B in FIG. 6, a first intermediate layer 341 made of a mixed material of the first material and the third material may be present between the first region 31 and the third region 33. A second intermediate layer 342 made of a mixed material of the second material and the third material may be present between the second region 32 and the third region 33. Depending on the manufacturing method, such intermediate layers may be inevitably formed. The intermediate layers (first intermediate layer 341 and second intermediate layer 342) may include a gradient region in which composition changes in the direction including the first direction. The presence of such intermediate layers may mitigate effects arising from changes in properties between regions, such as localized increases in magnetic resistance or localized decreases in mechanical properties.

### (Mechanical Property)

The second material may be harder than the third material. Since the second region 32 is basically a region where the coil member 10 is not present, making the second region 32 harder reduces defects or deformation of the main body portion 30. Thus, a new function of suppressing damage upon impact can be imparted to the main body portion 30. From this viewpoint, the first material may also be harder than the third material. Moreover, when the main body portion 30 is formed by pressurizing in the first direction a material containing magnetic powder and a curable material, as described later, positional control of the coil member 10 within the main body portion 30 becomes easier.

From the viewpoint of stably realizing the second material being harder than the third material, it is preferable that the second area ratio, which is an area ratio of the magnetic powder in a second cut surface obtained by cutting the second region 32 on a plane perpendicular to the first direction, be higher than the third area ratio, which is an area ratio of the magnetic powder in a third cut surface obtained by cutting the third region 33 on a plane perpendicular to the first direction.

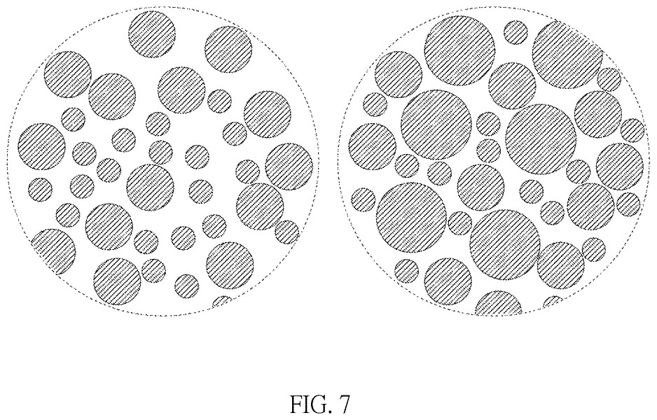

FIG. 7 illustrates that the shape distribution of magnetic powder differs. The left diagram corresponds to an observation image of the third cut surface, and the right diagram corresponds to an observation image of the second cut surface. In the region within the dashed circle, cross sections of the magnetic powder are hatched, and cross sections of the materials other than the magnetic powder (matrix), such as the binder, are shown unshaded. As described later, an example of the binder is a polymer, and in such a case, the magnetic powder is harder than the matrix. Therefore, as shown in FIG. 7, when the second area ratio (right diagram) is higher than the third area ratio (left diagram), the second material becomes harder than the third material.

From the viewpoint of both making the second region 32 harder and suppressing the adverse effect of increasing magnetic reluctance in the third region 33 to maintain appropriate magnetic and electrical characteristics of the coil component 100, the difference between the second area ratio and the third area ratio is preferably 1% or more and 5% or less based on the second area ratio.

### (Magnetic Powder)

The magnetic powder will be described herein. For example, the composition of the magnetic powder may be such that the magnetic material of the magnetic powder is formed of a conductive material, or such that the magnetic material of the magnetic powder is formed of an insulating material.

Specific examples of the conductive material include metallic materials, and when the magnetic powder is a metallic magnetic powder, its crystallographic structure is not limited. The structure may include a crystalline phase or an amorphous phase. Here, a crystalline material is defined as a material composed of a crystalline phase, an amorphous material is defined as a material composed of an amorphous phase, and a composite material is defined as a material composed of both a crystalline phase and an amorphous phase. When an X-ray diffraction spectrum obtained by a general X-ray diffraction method includes sharp diffraction peaks identifying the crystalline phase, the material contains a crystalline phase. When an X-ray diffraction spectrum obtained by a general X-ray diffraction method includes a broad peak representing an amorphous phase, the material contains an amorphous phase. When a DSC curve obtained by differential thermal analysis includes a crystallization peak (i.e., an exothermic peak due to a phase change from an amorphous phase to a crystalline phase), the material also contains an amorphous phase.

The material system of the magnetic material is not limited. Examples of crystalline materials include Fe—Si—Cr alloys, Fe—Ni alloys, Fe—Co alloys, Fe—V alloys, Fe—Al alloys, Fe—Si alloys, Fe—Si—Al alloys, pure iron, and Mn—Zn ferrite. Carbonyl iron powder is preferred as the pure iron powder. Examples of amorphous materials include Fe—Si—B alloys, Fe—P—C alloys, and Co—Fe—Si—B alloys. Examples of composite materials include Fϵ-Zr alloys, Fe—Zr—B alloys, Fe—Nb—B alloys, Fe—Si—B—Nb—Cu alloys, and Fe—Si—B—P—Cu alloys. When the magnetic material contains Fe, synergistic improvement in magnetic characteristics is particularly significant.

The chemical composition of the magnetic material is not limited. For example, an Fe—Si—Cr alloy may contain 1.0-10.0 mass % Si, 1.0-10.0 mass % Cr, and the balance consisting of Fe and impurities. An Fe—Ni alloy may contain 1.0-99.0 mass % Ni, and the balance consisting of Fe and impurities. Furthermore, an Fe—P—C alloy may contain 1.0-13.0 atom % P, 1.0-13.0 atom % C, and the balance consisting of Fe and impurities. The Fe—P—C alloy may further contain one or more optional elements selected from Ni, Sn, Cr, B, and Si. In this case, for example, the amount of Ni may be 0-10.0 at %, Sn 0-3.0 at %, Cr 0-6.0 at %, B 0-9.0 at %, and Si 0-7.0 at %. It is preferable that the Fe content be 65 at % or more. In addition, an Fe—Si—B—Nb—Cu alloy may contain 1.0-16.0 at % Si, 1.0-15.0 at % B, 0.50-5.0 at % Nb, 0.50-5.0 at % Cu, with the balance consisting of Fe and impurities. In this case as well, the Fe content is preferably 65 at % or more.

As a specific example of a case where the magnetic material of the magnetic powder is formed of an insulating material, Ni—Zn ferrite may be used.

The magnetic powder may be surface-insulated. When the magnetic powder is subjected to a surface insulation treatment, the insulation resistance of the main body portion 30 is improved. The type of surface insulation treatment applied to the magnetic powder is not limited. Examples include phosphate treatment, phosphate-salt treatment, and oxidation treatment. The magnetic powder may also have an insulating coating on the surface of the magnetic particles. This insulating coating may contain at least one selected from Si, P, and B, and may contain oxygen (O).

The magnetic powder may be a mixed material in which a plurality of powder materials are mixed. It is preferable that the magnetic powder be a ferromagnetic material, and more preferably a soft magnetic material.

The shape distribution of the magnetic powder refers to distributions concerning the shapes of the magnetic powder (spherical, needle-like, irregular, etc.) and distributions regarding particle size. Examples of the particle-size range include, for example, 0.10-50.0 μm. Specific examples of particle-size distribution include volume-based particle-size distribution obtained by laser diffraction/scattering particle-size measurement applied to the magnetic powder, and distributions of average circle equivalent diameters of the magnetic powder obtained by analyzing images captured by scanning electron microscopy of cut surfaces of the main body portion 30 (secondary electron images).

### (Insulation Property)

In the main body portion 30, the second material may have higher insulation property than the third material. In such a case, a new function of securing insulation with respect to external electrodes is imparted to the main body portion 30. When the second surface 302 is on the mounting-surface side (facing the substrate SB), short-circuiting on the mounting side is less likely to occur. In particular, when lower-surface electrodes such as the first intersecting-surface external electrode 41b and the second intersecting-surface external electrode 42b are provided, insulation between the lower-surface electrodes and the main body portion 30 is maintained, making short-circuiting between the lower-surface electrodes less likely to occur.

Although the configuration is different from that shown in the figures, when the second surface 302 is on the side opposite the mounting surface, the second region 32 may be more susceptible to impact. However, even if peeling occurs in the outer cover 60 due to impact, insulation breakdown is less likely to occur. From this viewpoint, the first material may also have higher insulation property than the third material.

One method for increasing the insulation property of the second material relative to that of the third material is to make the resistivity of the second region 32 greater than the resistivity of the third region 33.

When the magnetic powder contains metallic magnetic powder, from the viewpoint of stably realizing that the second material has higher insulation property than the third material, it may be preferable that the relative permeability μ2 of the second region 32 be smaller than the relative permeability μ1 of the first region 31. When the magnetic powder contains metallic magnetic powder, the likelihood increases that conductive paths that reduce insulation are formed inside the main body portion 30 due to contact between magnetic powder particles. Therefore, one means for relatively increasing the insulation property of the second region 32 is to increase the content of the insulating material in the second material. In this case, since the content of metallic magnetic powder is reduced, the relative permeability μ2 of the second region 32 tends to become smaller than the relative permeability μ1 of the first region 31.

In such a case, in the main body portion 30, the length h2 of the second region 32 in the first direction may be larger than the length h1 of the first region 31 in the first direction. Even when the relative permeability μ2 of the second region 32 is smaller than the relative permeability μ1 of the first region 31, if h2>h1, excessive increase in the magnetic reluctance of the second region 32 can be avoided.

As described above, when μ2<μ1, the following expression (1) may be satisfied. When expression (1) is satisfied, excessive increase in the magnetic reluctance of the second region 32 is unlikely to occur. Therefore, reduction of the magnetic characteristics of the coil component 100 can be avoided more stably.

$$\vert μ1 \times h 1 - μ2 \times h 2 \vert / ( μ1 \times h 1 ) \leq 0.1 \qquad ( 1 )$$

When the magnetic powder contains metallic magnetic powder, from the viewpoint of more stably realizing higher insulation of the second material than the third material, when the second region 32 is cut on a plane (XY plane) perpendicular to the first direction to obtain a second cut surface, and when the third region 33 is cut on a plane perpendicular to the first direction to obtain a third cut surface, at least one of the following conditions (A) or (B) may be satisfied:

(A) The second area ratio, which is the area ratio of magnetic powder on the second cut surface, is smaller than the third area ratio, which is the area ratio of magnetic powder on the third cut surface, and (B) The second average circle equivalent diameter, which is the average circle equivalent diameter of the magnetic powder on the second cut surface, is larger than the third average circle equivalent diameter, which is the average circle equivalent diameter of the magnetic powder on the third cut surface.

Regarding (A), by making the second area ratio<the third area ratio, μ2<μ3 tends to be realized. In this case, the area ratio of the binder becomes higher in the second region 32, making the insulation property of the second region 32 easier to increase. Referring to FIG. 7 as an example, when the left diagram showing a relatively lower magnetic powder area ratio corresponds to the second cut surface and the right diagram corresponds to the third cut surface, condition (A) is satisfied.

Regarding (B), when the average circle equivalent diameter of the magnetic powder is relatively large, the packing density tends to decrease. Therefore, by making the second average circle equivalent diameter>the third average circle equivalent diameter, μ2<μ3 tends to be realized. In this case, the area ratio of the binder tends to increase in the second region 32, making the resistivity of the second region 32 easier to increase.

From the viewpoint of more stably realizing higher insulation of the second material than the third material, the second material may contain insulating inorganic particles as a third component. Many insulating inorganic particles have higher breakdown voltage than the binder, and this tendency is significant particularly when the binder is a polymer. By containing inorganic particles as a third component in the second material, the possibility of insulation breakdown occurring in the second region 32 can be reduced. The type of inorganic particles is not limited. From the viewpoint of availability, oxide inorganic particles such as silica, alumina, and zirconia may be preferable.

From the viewpoint of more stably realizing higher insulation of the second material than the third material, the magnetic powder contained in the second region 32 may include metallic magnetic powder having an insulating coating on its surface. When the magnetic powder is metallic magnetic powder, the magnetic powder may form a conductive path upon insulation breakdown. Therefore, when the metallic magnetic powder has an insulating coating on its surface, the possibility of insulation breakdown occurring in the second region 32 can be reduced.

### (Prevention of Short-Circuiting in Coil Member)

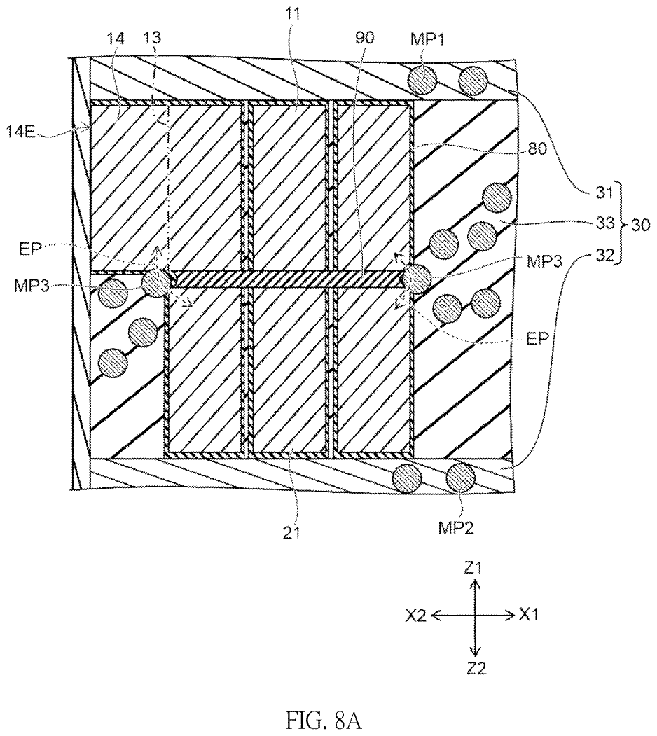

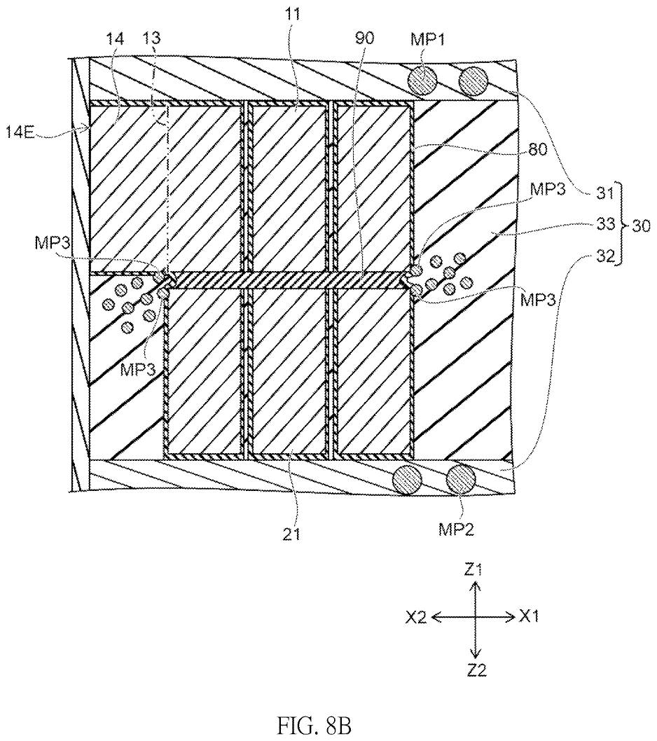

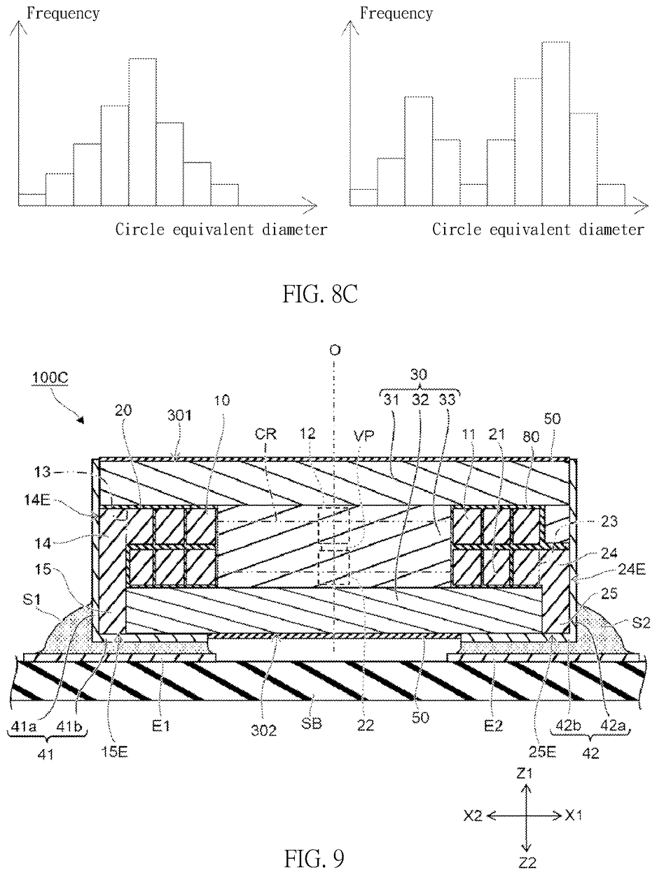

FIG. 8A is an explanatory diagram (comparative example) illustrating an example of the function of the main body portion of the coil component according to an embodiment of the present invention. FIG. 8B is an explanatory diagram (example of invention) illustrating an example of the function of the main body portion of the coil component according to an embodiment of the present invention. FIG. 8C is a diagram illustrating that the shape distribution of magnetic powder differs.

As shown in FIG. 8A, a coil insulator portion 80 is provided around the first spiral conductor portion 11 and the second spiral conductor portion 21, thereby preventing short-circuiting between turns of the same spiral conductor portion. In addition, an insulating interposer 90 is disposed as an insulator between the first spiral conductor portion 11 and the second spiral conductor portion 21, thereby preventing short-circuiting between a turn of the first spiral conductor portion 11 and a turn of the second spiral conductor portion 21 arranged alongside it in the first direction.

However, when the magnetic powder MP3 contained in the third region 33 includes metallic magnetic powder, if the particle diameter of the magnetic powder MP3 is larger than the thickness of the interposer 90, as shown in FIG. 8A, the magnetic powder MP3 may be positioned so as to form a short-circuit path EP between the turn of the first spiral conductor portion 11 and the turn of the second spiral conductor portion 21. Similar short-circuiting may also occur between the first lead-out portion 14 and a turn of the second spiral conductor portion 21, or between the second lead-out portion 24 and a turn of the first spiral conductor portion 11. When a material containing the magnetic powder MP3 is arranged around the coil member 10 and is pressurized to form the main body portion 30, the magnetic powder MP3 may come into contact with the conductors of the coil member 10 while partially breaking the insulation portions (coil insulator portion 80 and interposer 90), thereby increasing the likelihood that the above-described short-circuit phenomenon occurs.

Therefore, by making the shape distribution of the magnetic powder MP3 contained in the third material different from the shape distribution of the magnetic powder MP2 contained in the second material, a new function of suppressing short-circuiting in the coil member 10 can be imparted to the main body portion 30. In FIG. 8B, a small-diameter metallic magnetic powder, which is smaller than the diameter of the magnetic powder MP2 contained in the second material or the magnetic powder MP1 contained in the first material, is used as the magnetic powder MP3 contained in the third material. Therefore, even when the magnetic powder MP3 comes into contact with the conductor of the coil member 10 while partially breaking the insulation portions (coil insulator portion 80 and interposer 90), short-circuiting is less likely to occur.

The material constituting the interposer 90 is not limited as long as it has appropriate insulation property. The volume resistivity of the interposer 90 is preferably 1.0×10¹^{⁴} Ω·cm or more according to ASTM D257, more preferably 1.0×10¹^{⁵} Ω·cm or more, and still more preferably 1.0×10¹^{⁶} Ω·cm or more. The upper limit of the volume resistivity is not particularly restricted and may be 1.0×10²^{⁰} Ω·cm or less. It is also preferable that the interposer 90 exhibit excellent dielectric properties, specifically, a relative permittivity of 4.0 or less at 60 Hz according to ASTM D150, more preferably 3.5 or less, and still more preferably 3.0 or less. The lower limit of the relative permittivity is not particularly restricted and may be 1.0 or more. The volume resistivity and relative permittivity of the interposer 90 are measured using a material corresponding to the interposer 90, prepared to the required dimensions. The material corresponding to the interposer 90 can be identified, similarly to the coil insulator portion 80, by component analysis or analytical methods such as FT-IR.

The material constituting the interposer 90 may be an organic material, an inorganic material, or a composite material thereof. When the interposer 90 is formed of a composite material, the inorganic material may have a particulate shape and may be dispersed in a matrix composed of organic material. Examples of organic materials include polyimide resin, polyethylene resin, polypropylene resin, polyamide resin, polyester resin, polyamide-imide resin, polysulfone resin, polycarbonate resin, liquid crystal polymer resin, polyvinylidene fluoride resin, and polytetrafluoroethylene resin. Examples of inorganic materials, particularly those in composite materials, include oxides, carbides, nitrides, and inorganic salts. For example, silica, alumina, and zirconia may be used as oxides; silicon carbide and boron nitride as carbides and nitrides, respectively; and wollastonite, kaolin, and mica as inorganic salts. Among these, oxide-based materials such as oxides, silicates, and phosphates are preferable from the viewpoint of cost and insulation. For example, it is preferable that the inorganic material contain at least one selected from silicon (Si), phosphorous (P), boron (B), and calcium (Ca).

From the viewpoint of more stably reducing the possibility of the above-described short-circuit phenomenon, regarding the shape distribution of the magnetic powder, when the second region is cut on a plane perpendicular to the first direction to obtain the second cut surface, and the third region is cut to obtain the third cut surface, it is preferable that at least one of the following (a)-(d) be satisfied when comparing the second cut surface with the third cut surface:
(a) The third average circle equivalent diameter of the magnetic powder MP3 on the third cut surface is smaller than the second average circle equivalent diameter of the magnetic powder MP2 on the second cut surface;
(b) The third median diameter of the magnetic powder MP3 on the third cut surface is smaller than the second median diameter of the magnetic powder MP2 on the second cut surface;
(c) The third maximum circle equivalent diameter of the magnetic powder MP3 on the third cut surface is smaller than the second maximum circle equivalent diameter of the magnetic powder MP2 on the second cut surface; and
(d) In at least one of the second diameter distribution, which is the distribution of circle equivalent diameters of the magnetic powder MP2 on the second cut surface, and the third diameter distribution, which is the distribution of circle equivalent diameters of the magnetic powder MP3 on the third cut surface, two or more peaks are present, and a third peak diameter, which is a circle equivalent diameter at the maximum frequency of the largest-diameter-side peak in the third diameter distribution, is smaller than the second peak diameter, which is a circle equivalent diameter at the maximum frequency of the largest-diameter-side peak in the second diameter distribution.

Regarding (a), since smaller-particle-size magnetic powder tends to exist in the third region 33, when the main body portion 30 is formed by pressurizing the material containing magnetic powder MP3, even if the insulation portions (coil insulator portion 80 and interposer 90) on the surface of the annular conductor portion (first spiral conductor portion 11, second spiral conductor portion 21, and via part VP) are locally broken by the magnetic powder, short-circuiting inside the annular conductor portion is less likely to occur.

The difference between the second average circle equivalent diameter and the third average circle equivalent diameter is preferably 1% or more and 5% or less, based on the second average circle equivalent diameter. From the viewpoint of preventing short-circuiting inside the annular conductor portion (first spiral conductor portion 11, second spiral conductor portion 21, and via part VP), it is desirable that the third average circle equivalent diameter is small. However, when the average circle equivalent diameter becomes excessively small, the packing density tends to increase, which may reduce the packing density in the second region 32 and increase the magnetic reluctance of the second region 32. By keeping the difference within the above range, short-circuiting inside the annular conductor portion can be appropriately suppressed while preventing excessive increase in magnetic reluctance in the second region 32.

Regarding (b), since smaller-particle-size magnetic powder tends to exist in the third region 33, when the main body portion 30 is formed by pressurizing the material containing magnetic powder MP3, even if the insulating portion provided on the surface of the annular conductor portion is locally broken by the magnetic powder due to the pressurization, short-circuiting inside the annular conductor portion is less likely to occur.

The difference between the second median diameter and the third median diameter may be 1% or more and 5% or less based on the second median diameter. From the viewpoint of preventing short-circuiting inside the annular conductor portion, it is desirable that the third median diameter is small. However, since a smaller median diameter tends to increase the packing density, if the third median diameter becomes excessively small, the packing density in the second region 32 becomes relatively low, and an increase in the magnetic reluctance of the second region 32 becomes a concern. By keeping the above range, short-circuiting inside the annular conductor portion can be appropriately suppressed while suppressing an excessive increase in the magnetic reluctance of the second region 32.

Regarding (c), since smaller-particle-size magnetic powder tends to exist in the third region 33, when the main body portion 30 is formed by pressurizing the material containing magnetic powder MP3, even if the insulating portion provided on the surface of the annular conductor portion is locally broken by the magnetic powder MP3 due to the pressurization, short-circuiting inside the annular conductor portion is less likely to occur.

The difference between the second maximum circle equivalent diameter and the third maximum circle equivalent diameter is preferably 1% or more and 5% or less based on the second maximum circle equivalent diameter. From the viewpoint of preventing short-circuiting inside the annular conductor portion, it is desirable that the third maximum circle equivalent diameter is small. However, since a smaller maximum circle equivalent diameter may increase the packing density, if the third maximum circle equivalent diameter becomes excessively small, the packing density in the second region 32 becomes relatively low, and an increase in the magnetic reluctance of the second region 32 may become a concern. By keeping the above range, short-circuiting inside the annular conductor portion can be appropriately suppressed while suppressing an excessive increase in the magnetic reluctance of the second region 32.

It may be preferable that the second maximum circle equivalent diameter be 12.0 μm or more and 50.0 μm or less, and that the third maximum circle equivalent diameter be 2.0 μm or more and 10.0 μm or less. By keeping within these ranges, short-circuiting inside the annular conductor portion can be appropriately suppressed while increasing the likelihood of suppressing the influence of increased magnetic reluctance in the second region 32.

Regarding (d), since smaller-particle-size magnetic powder tends to exist in the third region 33, when the main body portion 30 is formed by pressurizing the material containing magnetic powder MP3, even if the insulating portion provided on the surface of the annular conductor portion is locally broken by the magnetic powder MP3 due to the pressurization, short-circuiting inside the annular conductor portion is less likely to occur. Among the two distributions of circle equivalent diameters shown in FIG. 8C, the distribution on the right has two peaks. Comparing the largest-diameter-side peaks of the two distributions, the peak on the right has a larger diameter. Therefore, the two circle-equivalent-diameter distributions shown in FIG. 8C correspond to the left one being an example of the third diameter distribution and the right one being an example of the second diameter distribution.

The difference between the second peak diameter and the third peak diameter is preferably 1% or more and 5% or less, based on the second peak diameter. From the viewpoint of preventing short-circuiting inside the annular conductor portion, the smaller the third peak diameter, the more preferable; however, since a smaller peak diameter tends to increase the packing density, if the third peak diameter becomes excessively small, the packing density in the second region 32 becomes relatively low, and an increase in the magnetic reluctance of the second region 32 becomes a concern. By keeping the above range, short-circuiting inside the annular conductor portion can be appropriately suppressed while suppressing an excessive increase in the magnetic reluctance of the second region 32.

The second diameter distribution preferably has a greater number of peaks than the third diameter distribution. In the second region 32, where relatively large-diameter magnetic powder is contained, by containing small-diameter magnetic powder to an extent at which peaks appear, it becomes easier to increase the packing density of the magnetic powder MP2, and the magnetic characteristics of the second region 32 become easier to improve. Among the two distributions of circle equivalent diameters shown in FIG. 8C, the distribution on the right, which is an example of the second diameter distribution, has two peaks.

When the magnetic powder MP3 contains metallic magnetic powder and the above short-circuiting is a concern, from the viewpoint of more stably reducing the possibility of the occurrence of short-circuiting, it is preferable that at least one of the second particle-size distribution, which is the volume-based particle-size distribution of the magnetic powder contained in the second region 32, and the third particle-size distribution, which is the volume-based particle-size distribution of the magnetic powder contained in the third region 33, have two or more peaks, and that the third particle size, which is the particle size at the maximum frequency of the largest-diameter-side peak in the third particle-size distribution, be smaller than the second particle size, which is the particle size at the maximum frequency of the largest-diameter-side peak in the second particle-size distribution.

Since smaller-particle-size magnetic powder tends to exist in the third region 33, when the main body portion 30 is formed by pressurizing the material containing magnetic powder MP3, even if the insulating portion provided on the surface of the annular conductor portion is locally broken by the magnetic powder MP3 due to the pressurization, short-circuiting inside the annular conductor portion is less likely to occur.

The difference between the second particle size and the third particle size is preferably 1% or more and 5% or less, based on the second particle size. From the viewpoint of preventing short-circuiting inside the annular conductor portion, the smaller the third particle size, the more preferable; however, since smaller particle sizes tend to increase the packing density, if the third particle size becomes excessively small, the packing density in the second region 32 becomes relatively low, and the magnetic reluctance of the second region 32 may increase. By keeping the above range, short-circuiting inside the annular conductor portion can be appropriately suppressed while suppressing an excessive increase in the magnetic reluctance of the second region 32.

The second particle-size distribution preferably has a greater number of peaks than the third particle-size distribution. In the second region 32, where relatively large-diameter magnetic powder is contained, by containing small-diameter magnetic powder to an extent at which peaks appear, it becomes easier to increase the packing density of the magnetic powder MP2, and the magnetic characteristics of the second region 32 become easier to improve.

While the above explanation compares the magnetic powder MP3 contained in the third region 33 with the magnetic powder MP2 contained in the second region 32, the magnetic powder MP1 contained in the first region 31 may have the same relationship with the magnetic powder MP2 contained in the second region 32. In this case, the shape distribution of the magnetic powder MP1 and the shape distribution of the magnetic powder MP2 may be identical or may differ. From the viewpoint of suppressing local increases in magnetic reluctance, it may be preferable for the shape distribution of the magnetic powder MP1 and the shape distribution of the magnetic powder MP2 to be identical. In an embodiment such as the present one, where the second surface 302 is the mounting surface, it may be preferable that the insulation of the second region 32 be relatively high, or that the hardness of the second region 32 be relatively high. From such viewpoints, it may be preferable for the shape distribution of the magnetic powder MP1 and the shape distribution of the magnetic powder MP2 to differ.

### (Binder)

In the main body portion 30, the binder contained in the second region 32 may contain a second polymer, and the binder contained in the third region 33 may contain a third polymer. Since the physical properties of polymers can be readily adjusted by adjusting the monomer composition and degree of polymerization, the characteristics of the binder can be easily controlled by including polymers. Examples of polymers include acrylic resin, silicone resin, epoxy resin, phenolic resin, urea resin, melamine resin, and polyester resin. The binder may also contain inorganic materials such as glass-based materials exemplified by water glass.

The weight average molecular weight of the second polymer may be larger than the weight average molecular weight of the third polymer. The second region 32 containing polymers with relatively large molecular weight tends to have high strength and high viscosity as a whole. In this case, the difference between the weight average molecular weight of the second polymer and the weight average molecular weight of the third polymer may be 1% or more and 5% or less, based on the weight average molecular weight of the second polymer. This allows stable enjoyment of the benefits of the second region 32 being high-strength and high-viscosity.

The density of unreacted groups in the second polymer may be lower than that in the third polymer. Examples of unreacted groups include active functional groups that readily react with other functional groups, such as glycidyl groups, isocyanate groups, and carboxyl groups, as well as functional groups having active hydrogen that reacts with such functional groups (e.g., hydroxyl groups, amino groups). When a polymer is polymerized using a radical polymerization catalyst, ethylenically unsaturated bonds may also remain as unreacted groups.

The second region 32 containing a polymer with relatively low density of unreacted groups tends to have high strength and high viscosity as a whole. In this case, the difference between the density of unreacted groups in the second polymer and the density of unreacted groups in the third polymer may be 1% or more and 5% or less, based on the density of unreacted groups in the second polymer. This allows stable enjoyment of the benefits of the second region 32 being high-strength and high-viscosity.

When the second material contains a polymerization catalyst for forming the binder and the third material also contains a polymerization catalyst, the content of the polymerization catalyst in the second material may be higher than that in the third material. The polymerization catalyst is appropriately selected according to the monomer used to form the polymer. Examples of polymerization catalysts include urethane polymerization catalysts such as 2-(dimethylamino) ethanol, epoxy polymerization catalysts such as tetrabutylphosphonium bromide, and olefin polymerization catalysts such as metallocene compounds. The second region 32 containing a polymer with relatively high catalyst content tends to have high strength and high viscosity as a whole. In this case, the difference between the catalyst content in the second material and that in the third material may be 1% or more and 5% or less, based on the catalyst content in the second material. This allows stable enjoyment of the benefits of the second region 32 being high-strength and high-viscosity.

The hardness of the binder in the second region 32 measured by nanoindenter may be smaller than that of the binder in the third region 33. The second region 32 containing a relatively hard binder tends to have high strength and high viscosity as a whole. In such a case, the difference between the nanoindenter hardness of the second binder and that of the third binder may be 1% or more and 5% or less, based on the nanoindenter hardness of the second binder. This allows stable enjoyment of the benefits of the second region 32 being hard and highly viscous.

The binder contained in the first region 31 may contain a first polymer. Specific examples of this polymer are the same as those of the second polymer or the third polymer. The binder contained in the first region 31 may contain inorganic materials. The first polymer may have the same composition as the second polymer or the third polymer, or may have a composition different from either.

### (Modified Examples)

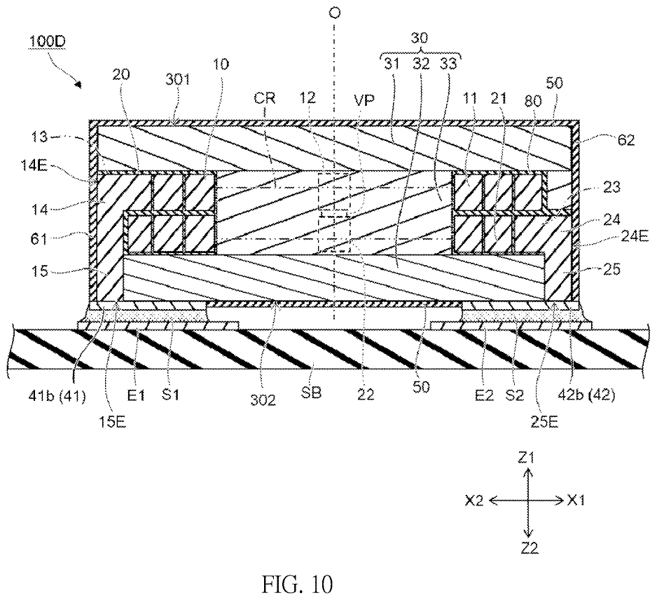

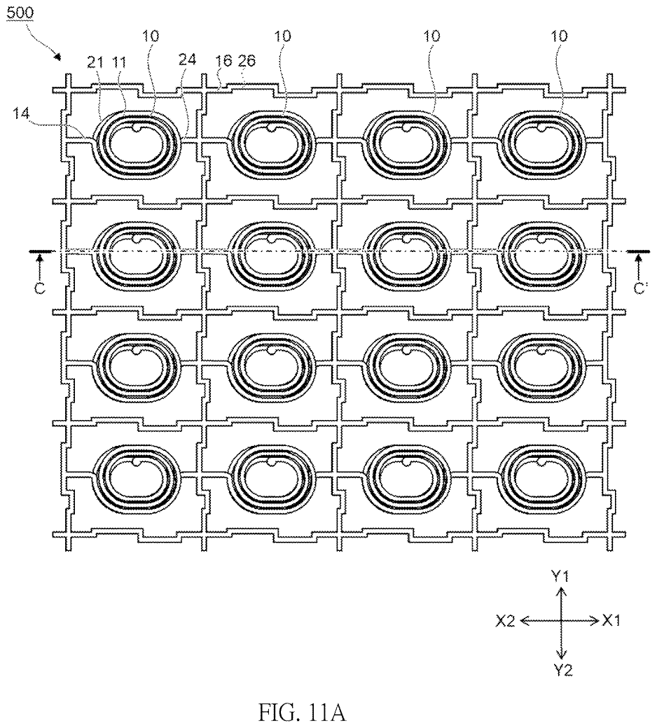

FIG. 9 is an XZ sectional view illustrating a modified example of the coil component (Part 3) according to an embodiment of the present invention. FIG. 10 is an XZ sectional view illustrating a modified example of the coil component (Part 4) according to an embodiment of the present invention.

Since the basic structure of the coil component 100C according to a modified example shown in FIG. 9 is common to that of the coil component 100, only the structural differences will be described, and descriptions of structures common to both will be omitted.

The coil component 100C in this example includes, in contrast with the coil component 100, a first connecting conductor portion 15 extending from the first lead-out portion 14 toward the second surface 302 side (Z2 side in Z1-Z2 direction), and a second connecting conductor portion 25 extending from the second lead-out portion 24 toward the second surface 302 side (Z2 side in Z1-Z2 direction). The first connecting conductor portion 15 is exposed from the second surface 302 of the main body portion 30 at the first connection end part 15E, and the second connecting conductor portion 25 is exposed from the second surface 302 at the second connection end part 25E. The first connection end part 15E electrically connects to the first intersecting-surface external electrode 41b as a part of the first end surface of the coil member 10, and the second connection end part 25E electrically connects to the second intersecting-surface external electrode 42b as a part of the second end surface of the coil member 10. Accordingly, the first external electrode 41 electrically connects to the first lead-out end part 14E and the first connection end part 15E, and the second external electrode 42 electrically connects to the second lead-out end part 24E and the second connection end part 25E. As a result, the electrical connection between the coil component 100 and the first substrate electrode E1 and second substrate electrode E2 is stabilized.

Since the basic structure of the coil component 100D according to one modified example shown in FIG. 10 is common to that of the coil component 100C, only the structural differences will be described, and descriptions of structures common to both will be omitted.

In the coil component 100D in this example, the first external electrode 41 includes only the first intersecting-surface external electrode 41b and does not include the first lateral external electrode 41a, and the second external electrode 42 includes only the second intersecting-surface external electrode 42b and does not include the second lateral external electrode 42a. In the coil component 100D, an outer cover 61 is disposed at a portion where the first lateral external electrode 41a would be located, and an outer cover 62 is disposed at a portion where the second lateral external electrode 42a would be located. Accordingly, in the coil component 100D, the first end surface of the coil member 10 is formed from the first connection end part 15E, and the second end surface is formed from the second connection end part 25E. The portion where the first substrate electrode E1 and second substrate electrode E2 electrically contact is located only on the mounting-surface side (Z2 side). Therefore, in the substrate SB on which the coil component 100D is mounted, the areas of the first substrate electrode E1 and second substrate electrode E2 can be reduced. In particular, the extending portion of the first substrate electrode E1 on the X2 side in the X1-X2 direction can be shortened, and the extending portion of the second substrate electrode E2 on the X1 side can be shortened. Thus, using the coil component 100D makes it possible to increase the mounting density of components on the substrate SB.

### (Manufacturing Method of Coil Component)

The manufacturing method of the coil component according to this embodiment is not particularly limited. One unrestricted example of such a manufacturing method is described below.

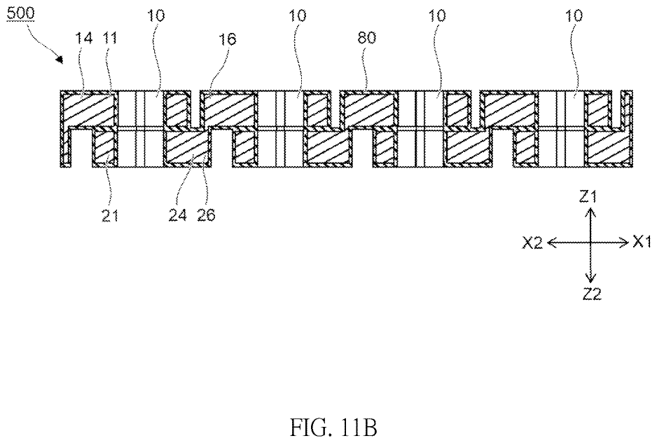

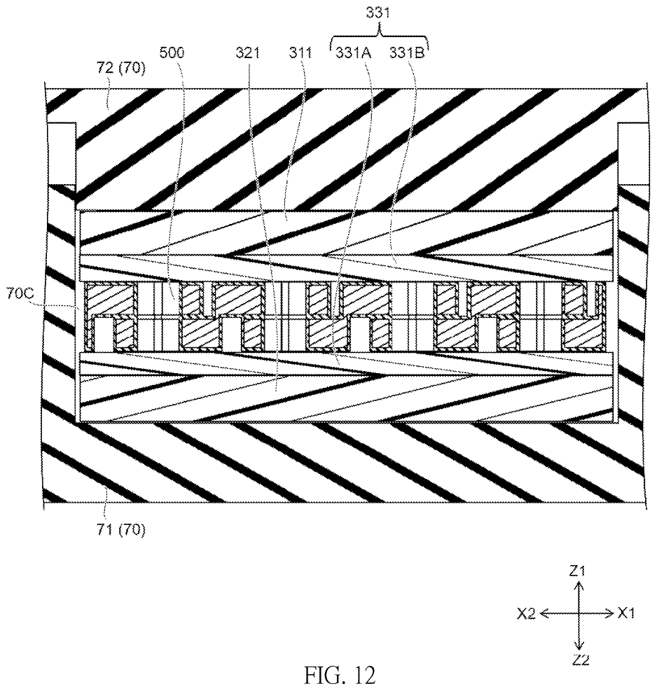

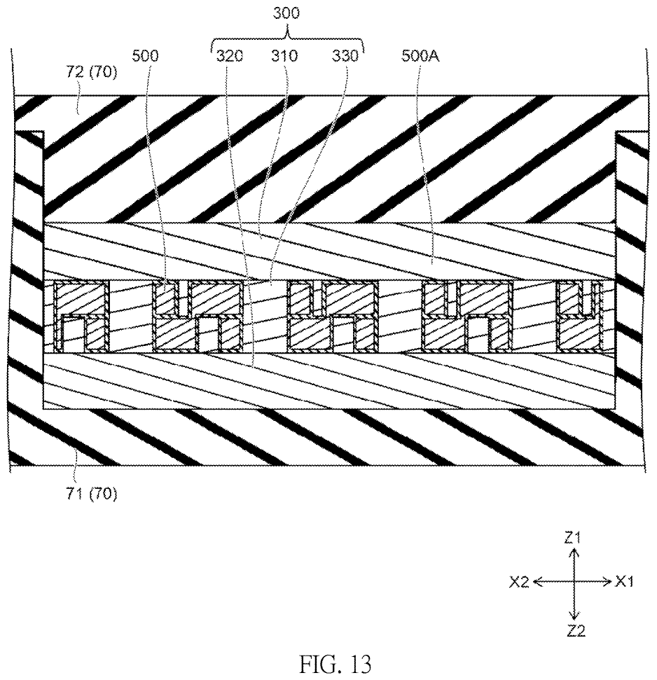

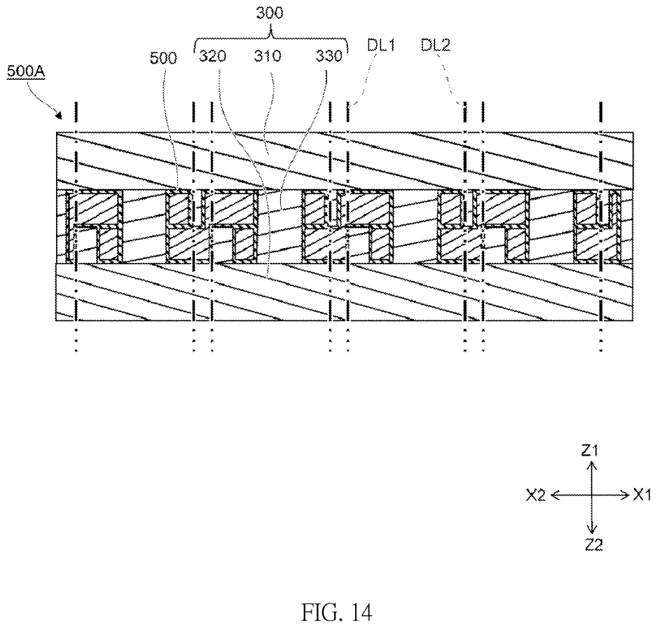

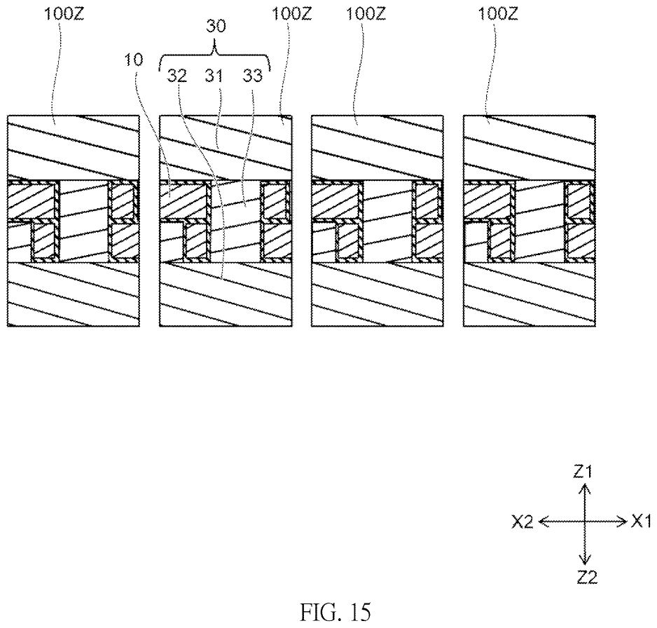

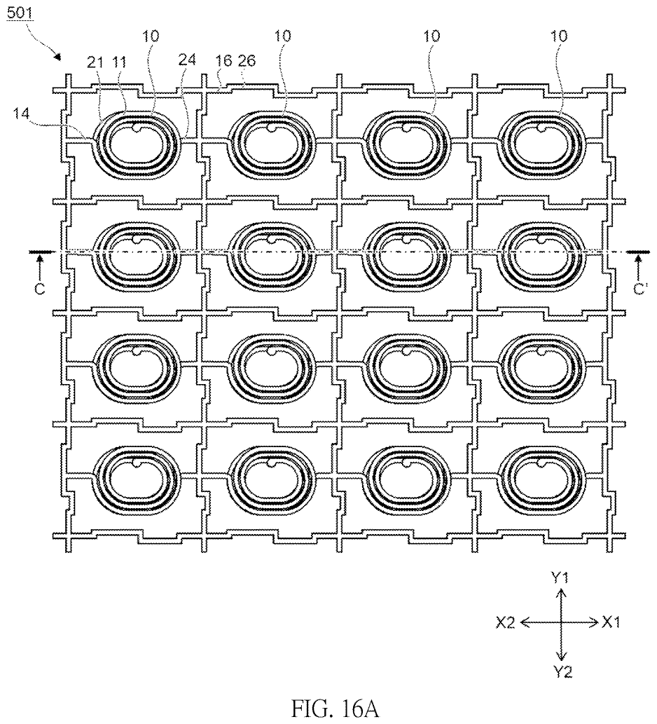

FIG. 11A is an XY plan view illustrating an example of the method of manufacturing a coil component (Part 1) according to an embodiment of the present invention, showing a coil array sheet. FIG. 11B is an XZ sectional view taken along line C-C′ of FIG. 11A. FIG. 12 is an XZ sectional view illustrating an example of the method of manufacturing a coil component (Part 2) according to an embodiment of the present invention, showing a state in which the coil array sheet and the like are arranged inside a mold cavity. FIG. 13 is an XZ sectional view illustrating an example of the method of manufacturing a coil component (Part 3) according to an embodiment of the present invention, showing a state in which molding is performed using a mold and a formed body is obtained. FIG. 14 is an XZ sectional view illustrating an example of the method of manufacturing a coil component (Part 4) according to an embodiment of the present invention, showing a state before cutting the formed body. FIG. 15 is an XZ sectional view illustrating an example of the method of manufacturing a coil component (Part 5) according to an embodiment of the present invention, showing a state in which the formed body is cut to obtain coil chips.

First, as shown in the XY plan view of FIG. 11A and the XZ sectional view of FIG. 11B, a plurality of coil members 10, each including the first spiral conductor portion 11 and the second spiral conductor portion 21, and the first lead out portion 14 and the second lead out portion 24, form a coil array sheet 500 in which they are interconnected to one another via the first connecting conductor portion 16 and the second connecting conductor portion 26. Although the manufacturing method is not limited, a plating process may be used as described below. Specifically, first, conductor layers (seed layers) are formed on both sides (the Z1 side and the Z2 side in the Z1-Z2 direction) of the surface of the insulating sheet substrate. Next, by performing an electroplating process, conductors including the first spiral conductor portion 11 and the second spiral conductor portion 21, the first lead out portion 14 and the second lead out portion 24, and the first connecting conductor portion 16 and the second connecting conductor portion 26 are formed on the conductor layers as plating deposits, as shown in FIG. 11B.

The method for forming the conductor is not limited. For example, by forming a pattern of an insulating layer that serves as a negative pattern of the conductor on the conductor layer on the insulating sheet substrate, and performing an electroplating process in which current is applied to the conductor layer, plating deposits may be accumulated on the exposed portions of the conductor layer surrounding the negative pattern, thereby forming a conductor having a desired shape. In this plating process, it is also possible to form the via part VP by filling plating deposits into the through holes of the sheet substrate.

Next, in the sheet substrate on which the conductor has been formed, at least a portion of the exposed part that is not covered by the conductor in the Z1-Z2 direction is removed. Specifically, when viewed in the first direction (Z1-Z2 direction), the sheet substrate including the region surrounded by the inner peripheries of the first spiral conductor portion 11 and the second spiral conductor portion 21 is removed. As described above, when a negative pattern made of an insulating layer is used in the conductor forming step, the insulating layer is first removed, and then, due to the removal of the insulating layer, the conductor layer exposed in the Z1-Z2 direction is removed. In this manner, a portion of the sheet substrate is exposed as an exposed portion in the Z1-Z2 direction, and a process for removing the exposed portion is carried out.

The specific removal process for the sheet substrate is appropriately set according to the material constituting the sheet substrate. The removal process is broadly classified into dry processes such as plasma etching, and wet processes such as wet etching. A portion of the sheet substrate may remain without being removed depending on the removal process. For example, when the sheet substrate is composed of a composite material including a matrix portion made of an organic material and inorganic material dispersed in the matrix portion, the sheet substrate may be removed by removing the matrix portion made of the organic material in the removal process.

Next, a coil insulator portion 80 is formed so as to cover the exposed surfaces of the conductors. Thus, the coil array sheet 500 is formed. In the above manufacturing method, among the insulator portions of the coil array sheet 500, areas on both sides in the Z1-Z2 direction covered by conductors are formed by remaining portions of the sheet substrate, rather than by the coil insulator portion 80. However, for simplicity, these are not shown in FIG. 11B and are treated as similar to the coil insulator portion 80.

The coil array sheet 500 obtained in this manner is placed into a cavity 70C of the mold 70. At this time, a first member 311 is positioned on one side in the first direction of the coil array sheet 500 including the coil member 10, and a second member 321 is positioned on the other side in the first direction of the coil array sheet 500 including the coil member 10, with a third member 331 positioned between the first member 311 and the second member 321. Specifically, as shown in FIG. 12, from the lower mold 71 side (Z2 side in Z1-Z2 direction) toward the upper mold 72 side (Z1 side in Z1-Z2 direction), the second member 321, one portion 331A of the third member 331, the coil array sheet 500, the other portion 331B of the third member 331, and the first member 311 are sequentially arranged. In this manner, a laminated structure including the coil array sheet 500, the first member 311, the second member 321, and the third member 331 is arranged inside the mold cavity 70C.

The first member 311 contains a first magnetic powder and a first curable material, and after shape-forming, becomes a first material body 310 made of the first material forming the first region 31. The second member 321 contains a second magnetic powder and a second curable material, and after shape-forming, becomes a second material body 320 made of the second material forming the second region 32. The third member 331 contains a third magnetic powder and a third curable material, and after shape-forming, becomes a third material body 330 made of the third material forming the third region 33 including the central region CR.

As described above, in this specification, “curable material” includes materials that cure and materials that cause curing (such as polymerization initiators). Specifically, compounds that contain active functional groups having high reactivity with other functional groups, such as glycidyl groups, isocyanate groups, and carboxyl groups, and compounds that contain functional groups having active hydrogen that reacts with such active functional groups (such as hydroxyl groups and amino groups), can be cited. Crosslinking substances that contain multivalent ions such as magnesium or calcium are also included in the curable materials. When the curable material is polymerized by a radical polymerization catalyst, compounds having ethylenically unsaturated bonds can also serve as curable materials. Polymerization catalysts that initiate or continue the polymerization reaction of the above substances that undergo the polymerization reaction are also included in the curable materials. Examples of polymerization catalysts include urethane polymerization catalysts such as 2 (dimethylamino) ethanol, epoxy polymerization catalysts such as tetrabutylphosphonium bromide, and olefin polymerization catalysts such as metallocene compounds.

The second member 321 and the third member 331 differ from each other in at least one item selected from the following group [1]-[6]:
[1] the composition of the second magnetic powder and the composition of the third magnetic powder,
[2] the particle size distribution of the second magnetic powder and the particle size distribution of the third magnetic powder,
[3] the content of the second magnetic powder in the second member 321 and the content of the third magnetic powder in the third member 331,
[4] the composition of the second curable material and the composition of the third curable material,
[5] the content of the second curable material in the second member 321 and the content of the third curable material in the third member 331, and
[6] when the second member 321 contains a second additive component other than the second curable material and the second magnetic powder, and when the third member 331 contains a third additive component other than the third curable material and the third magnetic powder, the composition of the second additive component and the composition of the third additive component.

Accordingly, the second material formed from the second member 321 and the third material formed from the third member 331 can be made different from each other, and the properties of the second region 32 and the third region 33 can be differentiated.

By performing the shape-forming process, including applying pressure inside the cavity, on the resulting laminated structure, the coil member 10 and the main body portion 30 are formed from the laminated structure, as shown in FIG. 13. Specifically, a formed body 500A is obtained, which includes the coil array sheet 500 containing multiple coil members 10 and a body portion forming member 300 that forms the main body portion 30. In addition to pressure, heating may also be applied in the shape-forming process. As described later, when the degree of curing of the third curable material in the third member 331 is low, the curing may be completed by heating.

The first member 311 and the third member 331 may have identical compositions, or they may be an integrated unit. When they are integrated, placement of the laminated structure into the cavity 70C of the mold 70 becomes easier. As a specific example of an integrated structure, the first member 311 and one part 331A of the third member 331 may be integrated. Although the second member 321 and the other part 331B of the third member 331 are different materials, they may be unified by preliminary heating or other treatment. In this case as well, placing the laminated structure into the cavity 70C is facilitated.

In the molding process, the first curable material through the third curable material may be cured. As a result, the first member 311 and the first material body 310 differ in composition, the second member 321 and the second material body 320 differ, and the third member 331 and the third material body 330 differ. Thus, each of the first to third members can be endowed with inherent functions from the viewpoint of molding.

As a specific example of such inherent functions, a positioning function of the coil array sheet 500 inside the mold during the shape-forming process in which the formed body 500A is obtained may be exemplified. Specifically, as shown in FIG. 12, when the first direction is along the vertical direction (Z1-Z2 direction), and when the second member 321 is arranged so as to be positioned below the coil array sheet 500, the second member 321 is made harder than the third member 331. As a result, when a compressive force in the first direction is applied to the mold 70, the coil array sheet 500 is easily embedded into the relatively soft third member 331, particularly into the interior of a portion 331A of the third member, but is less likely to be embedded into the relatively hard second member 321. Therefore, during the shape-forming process, the lower portion (Z2 side in Z1-Z2 direction) of the coil array sheet 500 stabilizes in a state in which it is in contact with the upper end of the second member 321. Accordingly, the positional accuracy of the coil array sheet 500 in the first direction (vertical direction) in the formed body 500A can be improved. Specifically, in the coil component 100, it becomes easy to adjust the distance between the Z2 side end of the coil member 10 in the Z1-Z2 direction and the second surface 302 to an appropriate range.

Making the second member 321 harder than the third member 331 may be realized by satisfying at least one of the following items (I) to (VI):
(I) For the laminated structure placed inside the cavity, the viscosity of the second curable material is higher than the viscosity of the third curable material;
(II) For the laminated structure placed inside the cavity, the degree of polymerization of the second curable material is higher than the degree of polymerization of the third curable material;
(III) For the laminated structure placed inside the cavity, the content of uncured material contained in the second curable material is smaller than the content of uncured material contained in the third curable material;
(IV) The second curable material and the third curable material each contain a polymerization catalyst, and for the laminated structure placed inside the cavity, the content of polymerization catalyst in the second curable material is higher than the content of polymerization catalyst in the third curable material;
(V) For the laminated structure placed inside the cavity, the volume fraction of the second magnetic powder contained in the second member 321 is higher than the volume fraction of the third magnetic powder contained in the third member 331; and
(VI) When the gel time, as defined in JIS K5600-9-1:2006, is measured for the second curable material and the third curable material contained in the laminated structure placed inside the cavity, the gel time of the second curable material is shorter than the gel time of the third curable material.

Similarly to the case where the second member 321 is harder than the third member 331, the first member 311 may also be harder than the third member 331. In that case, during the shape-forming process, the upper end (Z1 side in Z1-Z2 direction) of the coil array sheet 500 remains stable in contact with the lower end (Z2 side in Z1-Z2 direction) of the second member 321. Thus, the positional accuracy of the coil array sheet 500 in the first direction within the formed body 500A can be further improved. Specifically, in the coil component 100, the distance between the Z1 side end of the coil member 10 and the first surface 301 can be appropriately set.

The second member 321 may have higher insulation property than the third member 331. In this case, the insulation property of the second material formed from the second member 321 can be made higher than those of the third material formed from the third member 331.

As in this embodiment, the coil member 10 includes an insulator (such as coil insulator portion 80) covering the surface of the annular conductor portion and the third magnetic powder contains metallic magnetic powder. When the second member 321 is cut to obtain a second member cut surface and the third member 331 is cut to obtain a third member cut surface, it is preferable that at least one of the following items (i)-(iv) be satisfied:
(i) The third member average circle equivalent diameter, which is the average circle equivalent diameter of the third magnetic powder on the third member cut surface, is smaller than the second member average circle equivalent diameter, which is the average circle equivalent diameter of the second magnetic powder on the second member cut surface;
(ii) The third member median diameter, which is the median diameter of the third magnetic powder on the third member cut surface, is smaller than the second member median diameter, which is the median diameter of the second magnetic powder on the second member cut surface;
(iii) The third member maximum circle equivalent diameter, which is the maximum circle equivalent diameter of the third magnetic powder on the third member cut surface, is smaller than the second member maximum circle equivalent diameter, which is the maximum circle equivalent diameter of the second magnetic powder on the second member cut surface; and
(iv) At least one of the second member diameter distribution, which is the distribution of circle equivalent diameters of the second magnetic powder on the second member cut surface, and the third member diameter distribution, which is the distribution of circle equivalent diameters of the third magnetic powder on the third member cut surface, has two or more peaks, and the third member peak diameter, which is the circle equivalent diameter at the maximum frequency of the largest diameter side peak among the peaks in the third member diameter distribution, is smaller than the second member peak diameter, which is the circle equivalent diameter at the maximum frequency of the largest diameter side peak among the peaks in the second member diameter distribution.

When the formed body 500A is formed inside the cavity 70C of the mold 70, it is removed from the mold 70 and cut along the dicing lines DL1 and DL2 shown in FIG. 14. As a result, a coil chip 100Z having the main body portion 30 composed of the first region 31, the second region 32, and the third region 33, and having the coil member 10, is obtained. By forming outer covers 50 and 60 on this coil chip 100Z, and further forming the first external electrode 41 and the second external electrode 42, the coil component 100 is obtained.

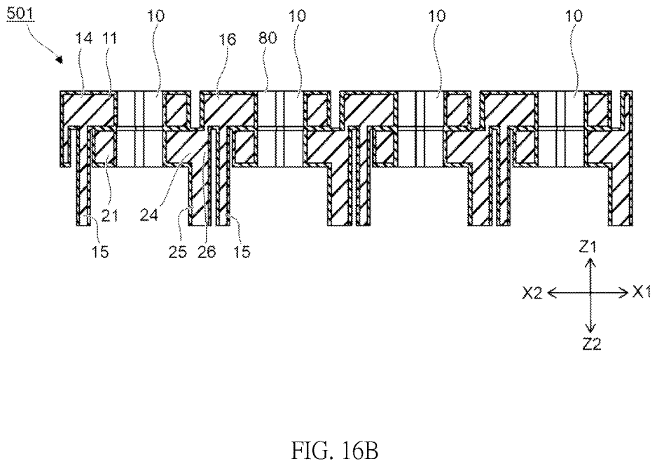

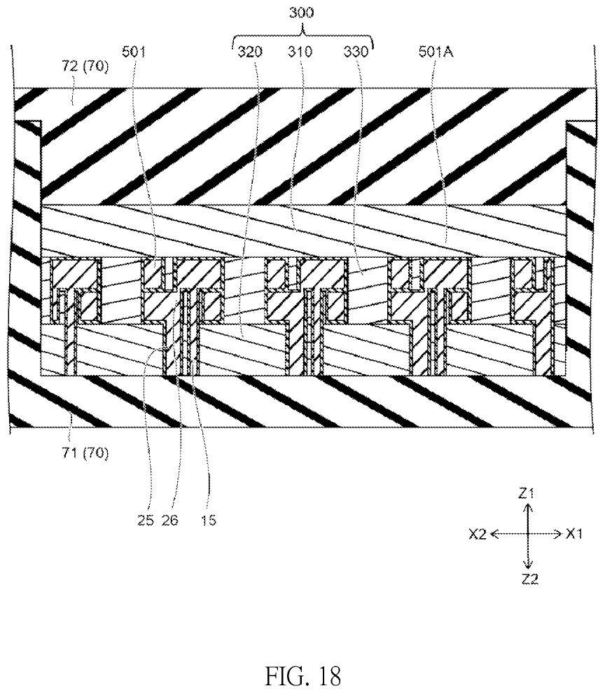

FIGS. 16A to 18 are explanatory diagrams illustrating an example of a method of manufacturing modified examples of the coil component (Part 1 to Part 3) according to an embodiment of the present invention. When the first connecting conductor portion 15 and the second connecting conductor portion 25 are provided as in the coil components 100C and 100D described above, the coil member 10 may be provided with the first connecting conductor portion 15 and the second connecting conductor portion 25 in the form of coil array sheet 501, as shown in FIG. 16A and FIG. 16B. In the coil array sheet 501, the second connecting conductor portion 25 and the second connecting conductor portion 26 are integrated with each other, and these are separated by cutting.

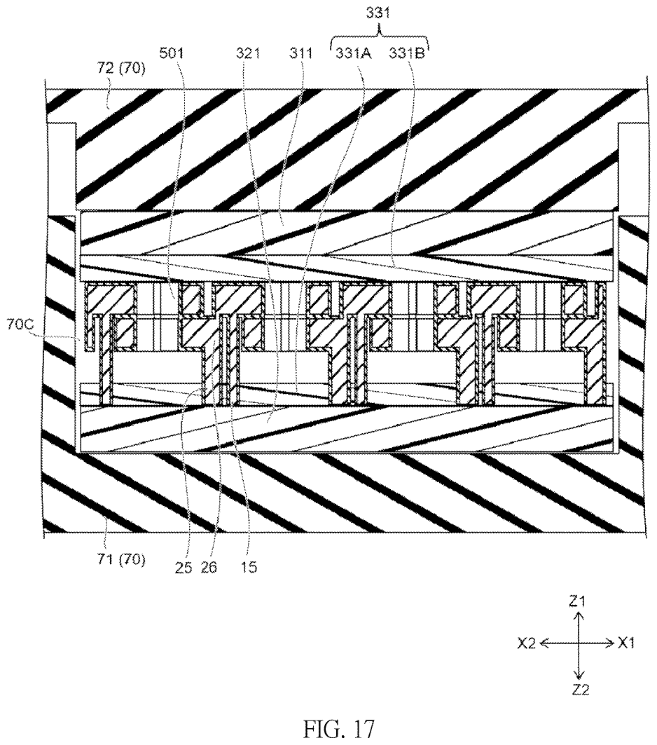

The shape-forming process for the coil array sheet 501 is substantially the same as that for the coil array sheet 500. In the example shown in FIG. 17, on the Z2 side in the Z1-Z2 direction, the portions of the coil array sheet 501 containing the second connecting conductor portion 25, the second connecting conductor portion 26, and the portion containing the first connecting conductor portion 15 (these portions being referred to as “protruding portions”) are embedded in a part 331A of the third member 331 and contact the upper end (Z1 side in Z1-Z2 direction) of the second member 321. Such arrangement can be achieved by making the second member 321 harder than the third member 331.

By closing the mold in this state and bringing the lower mold 71 and upper mold 72 closer together, the protruding portions become embedded in the second member 321, and the first spiral conductor portion 11 and the second spiral conductor portion 21 of the coil member 10 become embedded in the third member 331. As in the case of the coil array sheet 500, the lower end (Z2 side in Z1-Z2 direction) of the second spiral conductor portion 21 comes into contact with the upper end (Z1 side in Z1-Z2 direction) of the second member 321 while curing progresses in each member, and a molded body 501A is obtained in which the coil array sheet 501 is embedded in a body portion forming member 300 composed of a first material body 310 formed from the first member 311, a second material body 320 formed from the second member 321, and a third material body 330 formed from the third member 331. By performing a manufacturing process including cutting, similarly to the formed body 500A, the coil component 100C and the coil component 100D can be obtained.

### (Electronic/Electric Device)

An electronic/electric device according to one embodiment of the present invention is an electronic/electric device in which any of the coil components 100, 100A, 100B, 100C, and 100D described above is mounted. The coil components 100, 100A, 100B, 100C, and 100D are connected to the substrate SB via terminal members (the first external electrode 41 and the second external electrode 42) provided on exposed conductor portions (for example, the first lead out end part 14E and the second lead out end part 24E) located at and exposed from the two ends of the coil member 10. Because the electronic/electric device according to one embodiment of the present invention includes any of the coil components 100, 100A, 100B, 100C, and 100D, downsizing of the device is facilitated. In particular, the coil component 100D easily supports high density mounting, and therefore a device equipped with such a component can be downsized even more readily. Furthermore, even when a large current flows or high frequency is applied within the device, deterioration of the characteristics of the coil components 100, 100A, 100B, 100C, or 100D or failures due to heat generation are less likely to occur. The embodiments and examples described above are provided to facilitate understanding of the present invention and are not intended to limit the present invention, and accordingly, each element disclosed in the above embodiments is intended to include all design modifications and equivalents that fall within the technical scope of the present invention. For example, in the above description, the second surface 302 of the main body part 30 is positioned on the mounting-surface side during use and is positioned on the lower side during manufacturing. However, the present invention is not limited thereto. For instance, during manufacturing, the first surface 301 of the main body part 30 may be positioned on the lower side, and during use, the second surface 302 may be positioned on the mounting-surface side. In this case, by making the first member 311 harder than the third member 331, positional stability of the coil part 10 during molding can be improved; during use, by making the first region 31 harder than the third region 33, resistance to impacts such as collisions can be enhanced; and by making the second region 32 have higher insulation properties than the third region 33, the possibility of a short circuit between the first board electrode E1 and the second board electrode E2 can be reduced. Further, in the description of the method for manufacturing the coil components 100 and 100D, the third member 331 is described as being composed of two members arranged so as to sandwich the coil array sheet 500; however, the present invention is not limited thereto, and the third member 331 may be composed of a single member and may be arranged above or below the coil array sheet 500.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A coil component, comprising:
a coil member having an annular conductor portion having a central axis extending along a first direction and having two electrical end parts; and
a main body portion covering the annular conductor portion with a first surface and a second surface aligned in the first direction, and containing a magnetic powder and a binder,
wherein the coil member is exposed from the main body portion at a first end surface connected to one of the two electrical end parts of the annular conductor portion and at a second end surface connected to the other of the two electrical end parts of the annular conductor portion,
wherein the main body portion comprises:
a first region formed of a first material and including the first surface;
a second region formed of a second material and including the second surface; and
a third region formed of a third material and located between the first surface and the second surface in the first direction,
wherein the third region includes a central region in which the entire outer peripheral edge faces an inner peripheral surface of the annular conductor portion, and the second material and the third material differ in one or more selected from the group consisting of:
a composition of the magnetic powder,
a shape distribution, which is a distribution regarding shapes of the magnetic powder,
a content of the magnetic powder,
a composition of the binder,
a content of the binder, and
when a third component, which is a component other than the magnetic powder and the binder, is contained, a composition thereof, and a content thereof.

2. The coil component according to claim 1, wherein the first material and the second material are identical.

3. The coil component according to claim 1, wherein the first material and the second material differ in one or more selected from the group consisting of:
the composition of the magnetic powder,
the shape distribution of the magnetic powder,
the content of the magnetic powder,
the composition of the binder,
the content of the binder, and
when the third component other than the magnetic powder and the binder is contained, the composition thereof, and the content thereof.

4. The coil component according to claim 1, wherein the first material and the third material are identical.

5. The coil component according to claim 1, wherein the annular conductor portion contacts at least one of the first region and the second region at an end portion in the first direction.

6. The coil component according to claim 1, wherein the third region extends in the first direction to contact at least one of two end portions in the first direction of the annular conductor portion.

7. The coil component according to claim 1, wherein the second material is harder than the third material.

8. The coil component according to claim 7, wherein a second area ratio, which is an area ratio of the magnetic powder on a second cut surface obtained by cutting the second region on a plane perpendicular to the first direction, is higher than a third area ratio, which is an area ratio of the magnetic powder on a third cut surface obtained by cutting the third region on a plane perpendicular to the first direction.

9. The coil component according to claim 1, wherein the second material has a higher insulation property than the third material.

10. The coil component according to claim 9, wherein a resistivity of the second region is greater than a resistivity of the third region.

11. The coil component according to claim 9, wherein:
the magnetic powder contained in the second material includes a metallic magnetic powder, and
a relative permeability μ2 of the second region is smaller than a relative permeability μ1 of the first region.

12. The coil component according to claim 11, wherein a length h2 of the second region in the first direction is larger than a length h1 of the first region in the first direction.

13. The coil component according to claim 9, wherein when the second region is cut on a plane perpendicular to the first direction to obtain a second cut surface, and the third region is cut on a plane perpendicular to the first direction to obtain a third cut surface, at least one of the following is satisfied:
(A) a second area ratio, which is an area ratio of the magnetic powder on the second cut surface, is lower than a third area ratio, which is an area ratio of the magnetic powder on the third cut surface; and
(B) a second average circle equivalent diameter, which is an average circle equivalent diameter of the magnetic powder on the second cut surface, is larger than a third average circle equivalent diameter, which is an average circle equivalent diameter of the magnetic powder on the third cut surface.

14. The coil component according to claim 9, wherein the second material contains insulating inorganic particles as the third component.

15. The coil component according to claim 9, wherein the magnetic powder contained in the second material includes a metallic magnetic powder having an insulating coating provided on a surface thereof.

16. The coil component according to claim 1, wherein:
the annular conductor portion has an insulation portion on a surface thereof,
the magnetic powder contained in the third material includes a metallic magnetic powder, and
when the second region is cut on a plane perpendicular to the first direction to obtain a second cut surface, and the third region is cut on a plane perpendicular to the first direction to obtain a third cut surface, at least one of the following is satisfied:
(a) a third average circle equivalent diameter, which is an average circle equivalent diameter of the magnetic powder on the third cut surface, is smaller than a second average circle equivalent diameter, which is an average circle equivalent diameter of the magnetic powder on the second cut surface;
(b) a third median diameter, which is a median diameter of the magnetic powder on the third cut surface, is smaller than a second median diameter, which is a median diameter of the magnetic powder on the second cut surface;
(c) a third maximum circle equivalent diameter, which is a maximum circle equivalent diameter of the magnetic powder on the third cut surface, is smaller than a second maximum circle equivalent diameter, which is a maximum circle equivalent diameter of the magnetic powder on the second cut surface; and
(d) at least one of a second diameter distribution, which is a distribution of circle equivalent diameters of the magnetic powder on the second cut surface, and a third diameter distribution, which is a distribution of circle equivalent diameters of the magnetic powder on the third cut surface, has two or more peaks, and a third peak diameter, which is a circle equivalent diameter at a maximum frequency of a largest-diameter-side peak among the peaks in the third diameter distribution, is smaller than a second peak diameter, which is a circle equivalent diameter at a maximum frequency of a largest-diameter-side peak among the peaks in the second diameter distribution.

17. The coil component according to claim 1, wherein:
the annular conductor portion has an insulation portion on a surface thereof,
the magnetic powder contained in the third material includes a metallic magnetic powder,
at least one of a second particle size distribution, which is a volume-based particle size distribution of the magnetic powder contained in the second region, and a third particle size distribution, which is a volume-based particle size distribution of the magnetic powder contained in the third region, has two or more peaks, and
a third particle size, which is a particle size at a maximum frequency of a largest-diameter-side peak among the peaks in the third particle size distribution, is smaller than a second particle size, which is a particle size at a maximum frequency of a largest-diameter-side peak among the peaks in the second particle size distribution.

18. The coil component according to claim 1, wherein:
the binder contained in the second region contains a second polymer, and
the binder contained in the third region contains a third polymer.

19. The coil component according to claim 18, wherein a weight average molecular weight of the second polymer is larger than a weight average molecular weight of the third polymer.

20. The coil component according to claim 18, wherein a density of unreacted groups in the second polymer is lower than a density of unreacted groups in the third polymer.

21. The coil component according to claim 18, wherein:
the second material contains a polymerization catalyst for forming the binder,
the third material contains a polymerization catalyst for forming the binder, and
a content of the polymerization catalyst in the second material is higher than a content of the polymerization catalyst in the third material.

22. The coil component according to claim 18, wherein a hardness of the binder contained in the second region measured by a nanoindenter is smaller than a hardness of the binder contained in the third region measured by a nanoindenter.

23. A method for manufacturing a coil component, the coil component comprising a coil member having an annular conductor portion having a central axis in a first direction and having two electrical end parts, and a main body portion covering the annular conductor portion with a pair of intersecting surfaces aligned in the first direction and containing magnetic powder, and the method comprising:
providing a laminated structure by placing in a cavity of a mold:
the coil member;
a first member positioned on one side of the coil member in the first direction and containing a first magnetic powder and a first curable material;
a second member positioned on the other side of the coil member in the first direction and containing a second magnetic powder and a second curable material; and
a third member positioned between the first member and the second member and containing a third magnetic powder and a third curable material; and
obtaining a formed body having the coil member and the main body portion from the laminated structure, including increasing a pressure in the cavity,
wherein, in the formed body, a central region in which the entire outer peripheral edge faces an inner peripheral surface of the annular conductor portion is formed of a material based on the third member.

24. An electronic/electric device in which the coil component according to claim 1 is mounted, wherein the coil component is connected to a substrate via terminal members provided on exposed conductor portions located at each of two ends of the coil member and exposed to an outside.
